(19) United States
(12) Patent Application Publication
(10) Pub. No.: US 2003/0110503 A1
(43) Pub. Date: Jun. 12, 2003

(54) System, method and computer program product for presenting media to a user in a media on demand framework

(76) Inventor: Ronald M. Perkes, Novato, CA (US)

Correspondence Address: SQUIRE, SANDERS & DEMPSEY L.L.P, 600 HANSEN WAY, PALO ALTO, CA, 94304-1043, US

(21) Appl. No.: 10/280,880

(22) Filed: Oct. 25, 2002

Related U.S. Application Data
(60) Provisional application No. 60/330,581, filed on Oct. 25, 2001.

(51) Int. Cl. H04N 7/173; G06F 15/16

(52) U.S. Cl. 725/86; 725/105; 709/219

(57) ABSTRACT

A system, method and computer program product is disclosed for presenting media to a user in a media on demand framework. A plurality of media objects are defined for media from one or more media sources. Each media object comprises information relating to a media type and a metadata descriptor. A set of metadata descriptors is defined based on at least a portion of the media objects. An interface is presented to a user through which information is organized based on the set of metadata descriptors. The user is permitted to issue commands relating to the media objects via the interface. Media associated with the media objects from the one or more media sources is presented to the user based on the issued commands.

### CROSS-REFERENCE TO RELATED APPLICATION

This application also claims the benefit of U.S. Provisional Application No. 60/330,581, entitled “MEDIA-ON-DEMAND SYSTEM AND METHOD,” filed on Oct. 25, 2001.

### BACKGROUND

The last decade of digital media technology development have witnessed many well-publicized, over-hyped and problem-plagued advances and retreats at commercializing interactive television. Many definitions of what “interactive” TV (“iTV”) actually means have been put forth both conceptually and in the form of solutions. However the shared business goal is clear: find the secret formula to combine digital interactivity and product delivery to compel high-growth adoption targeted at the 1.5 billion TV sets currently in use worldwide.

A goal of delivering profitable two-way interactive video/media services remains a Holy Grail of the global information economy. While traditional PC sales growth has slowed, the potential for long-term growth in TV-centric realm is much larger. Certain limited interactivity has achieved widespread adoption in such systems as DSS, and other examples with greater interactivity such as MSNTV (formerly WebTV), UltimateTV, TIVO and RePlay have made interesting but as yet unprofitable strides. Today, more than 55 million households have digital service, and of those, 16+ million have iTV capability. In 2005, more than 220 million households are expected to be digital with almost 180 million households interactively participating in their TV programming. The TV-centric media possibilities are so compelling, no media Colossus can afford to be left out of the picture.

Further, the TV experience and its dominant penetration into modem households represents a qualitatively different relationship with the user/consumer—an emotional and psychological intimacy that is unmatched by the desktop PC experience. Growing interest in interactive media fueled by the Internet has ignited interest in the implications of the convergence of manifold computer, communication and media technologies. Combine the commercial implications of ubiquitous interactive media with the sociological ones, and you have a recipe for mind-boggling possibilities that will keep media companies, software firms, equipment makers, ISPs, investors, and users alike plugged in for the foreseeable future.

But just what is the secret needed to capture the iTV potential, and why has it been so elusive?

iTV trials have stumbled for several reasons, including:

There is a built-in inertia native to the “Lean Back” TV watching experience. TV is a tranquilizer, and many people consume it in order to enter a state where they don't have to think. The distinction is often made between “viewers” who presumably have a built-in one-way relationship to TV (viewing), and “users,” the word most often employed to refer to the participants in the two-way computer exchange (using).

That said, it-is clear that TV viewers can master new interactive techniques if motivated, as evidenced by the 17+ million US Direct Satellite customers nationwide, and by the growing popularity of interactive DVDs. The real gating factor is that most iTV user interaction isn't easy or interesting enough to overcome the inertia—to grow significant adoption rates and revenues or to change viewing behaviors. In many cases, the value of interactivity has not been made clear or compelling.

Many of the industry business and interaction models are overly ambitious and unrealistic, and the technology required to support these plans is more complex and expensive than hoped. Set tops have been too expensive to escape amortization and obsolescence curves, or are not powerful enough to enable a truly compelling experience.

Delivery technologies have built-in hurdles. Cable plants are problematic as two-way networks and bear little similarity to lab environments, and monopoly thinking has discouraged innovation; DSS systems deliver compelling local interactivity but don't provide true video-on-demand; PVR systems are promising but early and technically challenging, prone to hardware failure; WebTV-like systems do not provide a satisfactory internet experience for anyone exposed to the real web.

These solutions do not individually address the consumer's needs across the full spectrum of digital media in the home. Apart from the game industry, little progress has been made in leveraging the TV set beyond television programming or video viewing. Yet the ubiquity of the TV in the household proceeds unabated, challenging us to figure out the “interactivity thing.”

### SUMMARY

A system, method and computer program product is disclosed for presenting media to a user in a media on demand framework. A plurality of media objects are defined for media from one or more media sources. Each media object comprises information relating to a media type and a metadata descriptor. A set of metadata descriptors is defined based on at least a portion of the media objects. An interface is presented to a user through which information is organized based on the set of metadata descriptors. The user is permitted to issue commands relating to the media objects via the interface. Media associated with the media objects from the one or more media sources is presented to the user based on the issued commands.

In an embodiment of the present invention, the commands may include: browsing, selecting, previewing, purchasing, recording, collecting, sequencing and/or controlling the media objects. In another embodiment, the metadata descriptor of a media object may include information relating to: name of the media object, duration of the media object, genre of the media object, creator of the media object, affinity and parent groups of the media object, other media objects associated and linked to media object, rules for combining the media object with other media objects, owner of the media object, and/or value of the media object. In a further embodiment, visual objects associated with the media objects may be displayed to the user via the interface.

In yet another embodiment, the user may issue commands via a remote control. As an option in such an embodiment, commands may be issued via remote control commands by utilizing UP, DOWN, RIGHT, and/or LEFT arrow keys provided on remote control. In even another embodiment, one or more media objects may be linked together in response to at least one command issued by the user. In an additional embodiment, the interface may include a program guide that provides information about: media being presented to the user, media available for presenting to the user, and/or the order in which media objects can be combined and simultaneously presented to the user. In another embodiment, the media may be presented to the user via one or more frames on a visual display. In still another embodiment, the user may be permitted to search for media objects via the interface based on the metadata descriptors of the media objects. As an option, a plurality of media objects for media from one or more media sources may be locally cached (i.e., proximal to the user's end of the system) so that user access to each on demand media object can be expedited. As another option, the media associated with the media objects from the one or more media sources may be presented on demand to the user based on the issued commands.

### BRIEF DESCRIPTION OF THE DRAWINGS

FIG. 1 is a schematic diagram of a New/Existing User Site Access/Sign On Process used in an embodiment of the present invention;

FIG. 2 is a schematic diagram of the Application Process block of FIG. 1 in accordance with an embodiment of the present invention;

FIG. 3 is a diagram illustrating a Predictive Caching and Content Intermediation Process used in an embodiment of the present invention;

FIG. 4 is a diagram illustrating a Delivery Scheduler Component and Script used in an embodiment of the present invention;

FIG. 5 is a diagram illustrating a Content Manager Component and Script used in an embodiment of the present invention.

FIG. 6 is a diagram of a network architecture of a Broadcast Agent, Master Agent and Viewer Agent in accordance with an embodiment of the present invention;

FIG. 7 is a Broadcaster Schematic detailing functions performed by a Broadcast Agent (software operating on a first remote computer location) in accordance with an embodiment of the present invention

FIG. 8 is a Master Agent Schematic detailing functions performed by a Master Agent (operating on a server) in accordance with an embodiment of the present invention;

FIG. 9 is a Viewer Schematic detailing functions performed by a Viewer Agent (software operating on a second remote computer location) in accordance with an embodiment of the present invention;

FIG. 10 is a Viewer Schematic detailing additional functions performed by a Viewer Agent in accordance with an embodiment of the present invention;

FIG. 10A is a flowchart of a process for delivering content utilizing a master agent in accordance with an embodiment of the present invention;

FIG. 11 is a schematic diagram of an illustrative network system with a plurality of components in accordance with an embodiment of the present invention;

FIG. 12 is a schematic diagram of a representative hardware environment in accordance with an embodiment of the present invention;

FIG. 13 is a flowchart of a process for presenting media integrated from a plurality of media sources to a user to provide an integrated media experience for the user in a media on demand framework in accordance with an embodiment of the present invention;

FIG. 14 is a schematic diagram of an exemplary implementation of a media on demand framework in accordance with an embodiment of the present invention;

FIG. 15 is a screen navigation flow diagram in an extended programming guide in a media on demand framework in accordance with an embodiment of the present invention;

FIG. 16 is a screen navigation flow diagram for presenting television, video and music media in an extended programming guide in a media on demand framework in accordance with an embodiment of the present invention;

FIG. 17 is a screen navigation flow diagram for presenting games and Internet media in an extended programming guide in a media on demand framework in accordance with an embodiment of the present invention; and

FIG. 18 is a schematic diagram of a virtual media appliance stack 1800 for providing picture-in-picture and picture-on-picture capabilities in a media on demand framework in accordance with an embodiment of the present invention

### DETAILED DESCRIPTION

Although the following detailed description contains many specifics for the purpose of illustration, one of ordinary skill in the art will appreciate that many variations and alterations to the following description are with in the scope of the invention. Accordingly, the following preferred embodiment of the invention is set forth without any loss of generality to, and without imposing limitations upon, the claimed invention.

A preferred embodiment of the invention includes a Exchange Agent operating one or more conventional web server machines with standard server software, one or more Advertising Content Providers (who provide only Advertising Content) operating one or more conventional web server machines with standard server software, one or more Viewing Content Providers (providing Viewing Content such as streaming video or music, movies or non streaming media such as e-books or photography) operating one or more conventional web server machines with standard server software. The servers and computer are connected to a computer network, such as the Internet, which enables the servers and computer to communicate with other servers, computers or Internet accessible Appliances via the Internet, Intranets and other networks, standard email, instant messaging and other communication technologies.

In the preferred embodiment of the invention, installed on the Exchange Agent's server or servers, and/or installed on a third party's server or servers and connected to the Exchange Agent's server or servers (or any combination thereof), is appropriate standard server applications and standard and enhanced Internet based monitoring software and profiling software. The Exchange Agent's server or servers, in conjunction with the monitoring and profiling software, operate to collect information about consumers' Cross Technology Usage (the “collected information”). As used herein, “Cross Technology Usage” refers to the use by the consumer of not only Internet and Internet delivered video and streaming and downloadable music (such as MP3s), gaming and television capabilities of their computer, but their usage of connected DVD and CD players, high definition television (HDTV) and broadcast television and the usage, existence and/or non-existence of other peripherals and components connected to their computers. The collected information can include the type of digital media the consumer views or listens to (Internet, movies, video, music, DVD, CD, TV/HDTV, etc.) and details about that digital material (i.e., genre, title, run time, artist, etc.), details regarding on-line viewing, such as URLs, on-line purchasing habits, and genre classifications of the consumer's on-line participatory habits, such as contests, advertising involvement and other on-line and interactive TV interactions. In addition, the monitoring software can collect information regarding what peripherals are and are not connected to the consumer's computer.

In addition, the present invention optionally utilizes at the consumer end a computing based Appliance with continuous Internet access, such as a DSL, wireless or Cable connection, but the present invention will accommodate any currently known or anticipated method of Internet connection. The appliance also allows for viewing of television programming, listening to streaming audio via speakers, viewing streaming video on a monitor and listening to CD-ROM or viewing DVD content from a CD-ROM/DVD player. Such a multimedia entertainment center that may be utilized in the present invention as an appliance may be one described in U.S. patent application Ser. No. 09/125,803, entitled MULTIMEDIA COMPUTER AND TELEVISION APPARATUS, which is incorporated in its entirety herein by reference. The appliance has loaded on it the Client Software.

Cross Technology Usage Collection/Profiling.

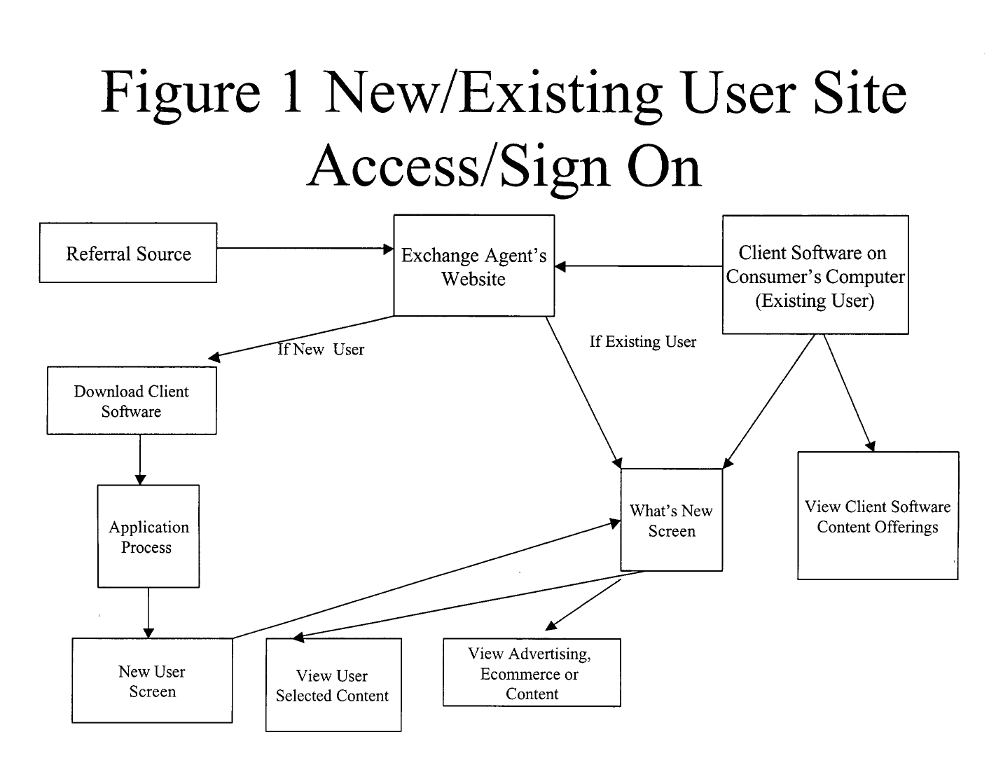

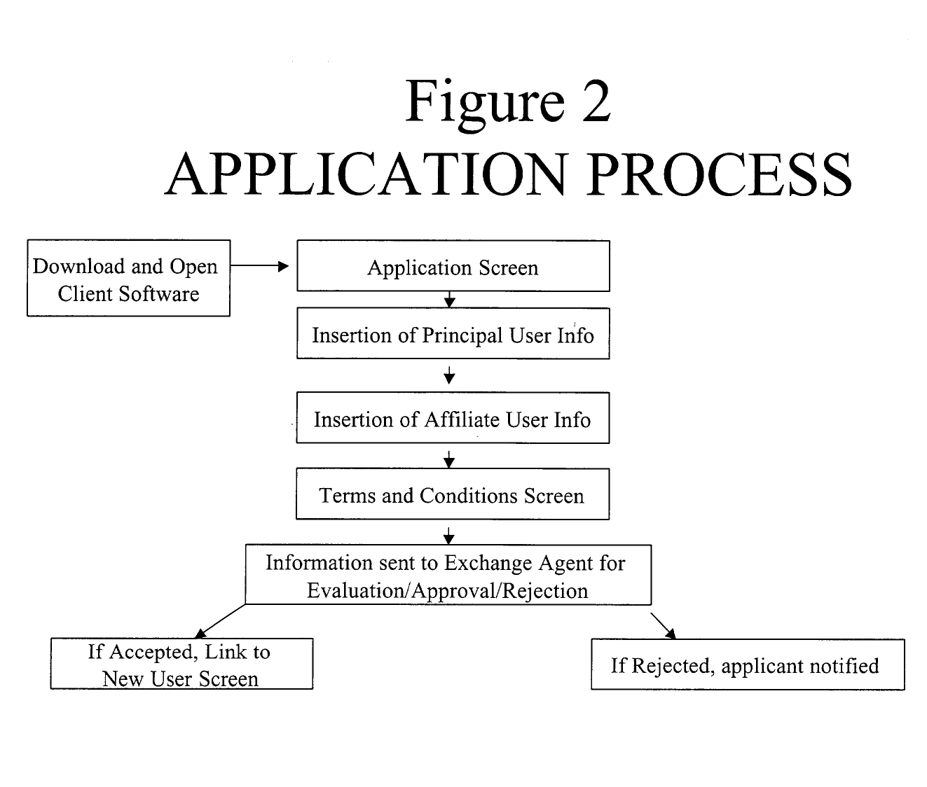

In the present invention, the consumer either receives the Client Software preloaded on a computer or consumer electronics equipment, or downloads the client Software from the Exchange Agent's website. The consumer engages in an application process, whereby the consumer will provide information such as their geographical location, sex, birthdate and personal interests, and apply to become a Member to the service. Additional information may be collected to further refine the profiling process. FIG. 1 shows a sequence of events relating to a user accessing and/or signing on to the service, according to the invention. FIG. 2 shows the sequence of events of the application process block of FIG. 1. In FIG. 1, if a user is a new user, such as one referred to the exchange agent by a referral source, the user accesses the exchange agent's website and downloads the client software. An application process is then executed from the downloaded client software. As shown in FIG. 2, the application process provides an application screen to the user, in which the principal user, as well as any affiliate users, can enter in information used as the basis of a “profile” on the user or users. The user is then presented with a “terms and conditions” screen, and the user-provided information is sent to the exchange agent for evaluation. Upon evaluation, the user is either approved or rejected. If approved, the user is provided with a link to a New User Screen; if rejected, the user is notified. Referring back to FIG. 1, an existing user accesses the exchange agent's website via the client software already present on the client's computer. The user can then view client software offerings, as well as “What's New” information provided on a “What's New” screen. The user can view selected content, advertising, or e-commerce information.

The Client Software on the consumer's computer collects, stores and transmits to the Exchange Agent's server or server's information regarding the consumer's Cross Technology Usage. In the present invention, the software takes the form of a Universal Media Player, which acts as a player for all digital entertainment viewed by the consumer. The Universal Media Player obtains logs on the web sites visited by the consumer, whereby the metatags obtained from those web sites are collected to obtain information regarding the types of web sites (e.g., sports, entertainment) the user prefers. The server also logs requests for content from the consumer. A log is also obtained on the television viewing habits of the consumer, by obtaining information obtained from the television signal itself or in combination with a TV-program database, for example, information that indicates the type of programming being watched (that information is also used by a V-chip, and may be encoded in the H-sync or V-sync interval of a television signal). Also, meta data, tags and other meta information embedded in CDs and DVDs played in the DVD/CD ROM Player are logged by the Universal Media Player. Using metatags associated with digital music files, and audio CD track and serial number information in combination with an audio CD database, music listening habits are also logged and the information transmitted to the server or servers. Other types of media that are accessed and played on the cross-media entertainment center may also be obtained and stored in a log, to further refine the profile of the consumer.

The Client Software running on the consumer's computer is designed to enable the consumer to program, store or bookmark favorite TV shows, downloadable/streaming video content, downloadable/streaming music content, video games and other content into sets of personalized preferences that cross the various types of viewing and listening technologies. These bookmarks are also collected and processed in the profiling function, thereby enhancing that function.

Using standard web-based monitoring, logging and collection software, the Exchange Agent's servers collect the collected information via the Internet. On the occasion of the first collection of that information, the information that is collected dates from the consumer's registration with the system. At the time of subsequent collections, the information collected is dated from the most recent previous collection. Collection of information can be done on a regular or irregular basis selected by the consumer or the server software.

The profiling software on the Exchange Agent's server or servers stores advertising, e-commerce and/or content and or content links with metatags, which refer to metadata, contained in the various advertising, E-commerce, content and content links stored on those servers. This metadata may, on all content, include the Title, Content Type, Description and Keywords applicable to that content item. Certain content items may have additional metadata connected to them. For example, movies may have information regarding the stars and actors in a film, and information regarding the director, the existence of sequels, prequals, previous versions or later remakes of the film. Music items may list the artist, album Key Instruments (electric Guitar, piano, strings, etc.). Metadata can be further refined to include, for movies, the movie genre (classical, action, comedy, etc.); or, for music, the genre, chart standing, tempo of the music, decade of release and more subjective items such as beat, voice type and mood. E-commerce and advertising metadata will include purchase transaction information, additional information links, value and desired targeted demographic, among other desired information.

The information collected regarding the consumer's Cross Technology Usage is then categorized according to the content types referred to above, collated and delivered to the profiling software maintained by the Exchange Agent or a third party service. Content items may be part of multiple categories. For example, the profiling software processes the information and compares it to one or more databases of content grouped in similar categories and classifications.

The present invention uses the collected information and implements standard and enhanced profiling and monitoring techniques to determine the interests of a consumer. Broadcast television and digital content, including but not limited to streaming video and music, DVD, audio CDs, Advertising Content and E-Commerce opportunities, are categorized into groups of varying degrees of refinement. For instance, sports, movies, music and television may form a first tier set of categories. Further refinement may develop sub categories such as baseball, action movies, and country music and television comedy. Increases in the number of participants in the profiling process permits even further refinement of the groups. In the preferred embodiment of the invention, the profiling groups will be refined to the point where the consumer will be delivered more specific content, such as San Francisco Giants baseball-related content, Bruce Willis action movies, N'sync music, videos and concerts and original Star Trek television episodes. For example, audio items may be further divided into music, and then into classical, instrumental, pop and other more refined categories. In addition, items can be associated together on a more subjective and flexible basis. For instance, certain advertising (i.e. beer or popcorn commercials) can be associated with sporting events. The collected information and categorized content are processed to select content that meets the consumer's perceived interests (the “selected content”).

A further refinement of the profiling process will also permit the pushing to the consumer of targeted advertising and e-commerce opportunities, and will create a targeted and precisely defined consumer base rich with opportunities for advertising and e-commerce.

Selected content may either be Viewing Content, Listening content, and Advertising Content or E-Commerce opportunities. Selected content may either be based in the Exchange Agent's, Advertiser's or Content provider's servers. In the present invention, the Exchange Agent's servers evaluates the consumer's perceived preferences and, using predictive models, determines content types that might be of interest to the consumer. Selected Content is in the form of links to that content on the content provider's website. The present invention downloads those links to the consumer's computer for management by the Content Manger function of the software on the consumer's computer.

In the present invention, selected content links that are downloaded are managed in several ways as described herein. It may appear as a link, in a preview format, as a full download or as a partial “near on demand” download. The selected content is then further analyzed and narrowed based upon implementation of the Network Management tools disclosed herein. As related to the present invention, the Network Management tools analyze the configuration of the targeted consumer's computer configuration to determine the storage availability based on the extent of available hard drive storage and thus the size of the proposed download. In addition, the present invention analyzes the consumer's Internet access habits and bandwidth availability to determine the best time to schedule a download of the selected content and selected content links. Giving the targeted consumer the ability to set preferences as to the amount of content to be downloaded and the download time are optional features of this method. In addition, the method can be implemented to enable, as an optional function, the automatic evaluation of storage availability and download timing, and to enable the consumer to initiate an immediate download and either storage for future viewing or viewing of the content at the point a sufficient amount of the content is downloaded to ensure a reliable uninterrupted viewing experience.

The Delivery Scheduler Script.

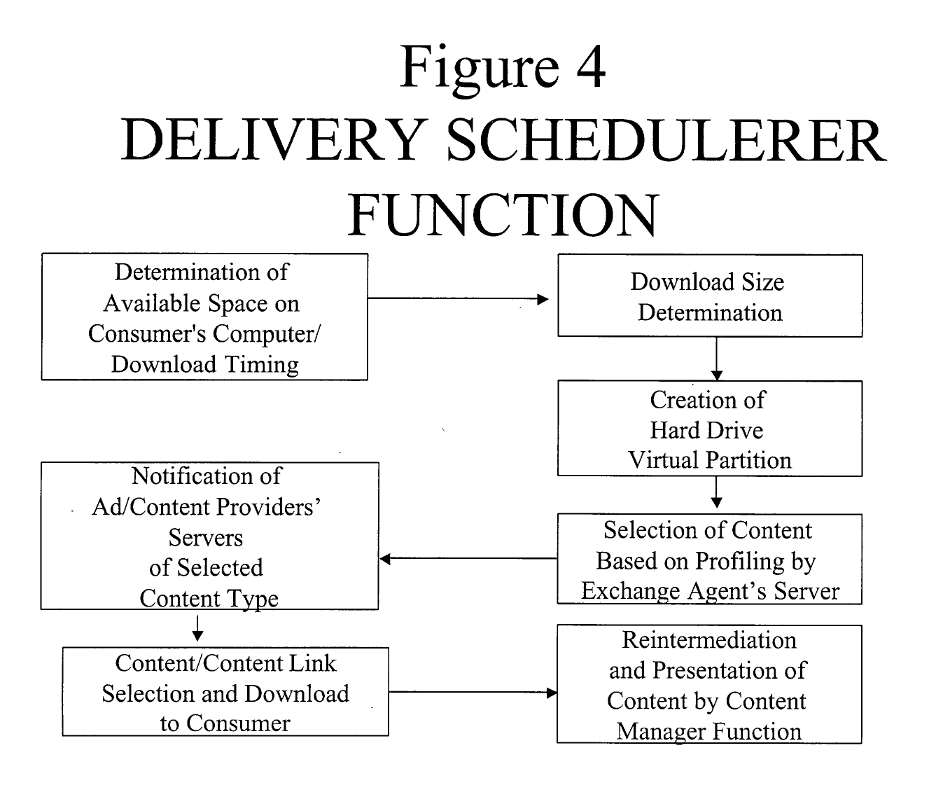

FIG. 4 shows the various steps involved for the Delivery Scheduler function. In the preferred embodiment of the invention, the Delivery Scheduler function software resides on the central server or servers, and is activated at predetermined times to access a particular consumer's computer or a number of consumer's computers. The Delivery Scheduler function determines the amount of free hard disk space on the consumer's computer, and determines the amount of space to allocate to a download to that hard drive using one of two methods. In one method, after being presented with the amount of available hard disk space on the computer, the consumer can select the amount of hard drive space to allocate to receiving delivered content. Using that method, the amount of space available for future downloads will be restricted to the consumer's selected amount. In another method, the consumer allows the Delivery Scheduler function to apply an algorithm to determine a measurement of the size of an acceptable download. That algorithm is: A×B=C, where A is the available hard disk drive space, B is a percentage of that available space determined by the consumers system configuration and considerations related to hard drive performance as it nears full capacity, and C is the acceptable download size.

Based either upon the selection by the consumer or application of the above algorithm, the method then creates a virtual partition of the hard drive or uses any one of several methods to reserve the selected amount of hard drive space, which methods are known to those skilled in the art. This reservation may be fixed for all future downloads or fluctuate (if determined by The Delivery Scheduler function on a download by download basis).

The Delivery Scheduler function then analyzes the selected content links and, using the priority of the consumer's perceived interest in the type and the size of the selected content, eliminates from the download queue lower priority or excessively large content according to the priorities established by the profiling method. For instance, if a consumer has 1.5 gigabits of available hard disk space at the time of the Delivery Scheduler hard drive scan (Algorithm value A), and the value of B is 85%, The Delivery Scheduler function calculates a download size of 1.275 gigabits.

Assume, for example, that the selected content and selected content links are made up of two (2) music videos consisting of 80.5 megabytes, a movie of 970 megabytes, a television episode sized at 255 megabytes and Messaging/Advertising Content/E-commerce opportunities consisting of 120 megabytes (a total of 1.4255 gigabits). The Delivery Scheduler function will first determine if an acceptable download will accommodate downloading all of the selected content and selected content links. In the example, the total download size is 1.4255 gigabits. Since this figure is below the acceptable download calculation (1.5×85%=1.275), The Delivery Scheduler function will first eliminate the lowest priority content item and determine that the balance falls within the acceptable download size. If, after eliminating the lowest priority content, the Delivery Scheduler function determines that the remaining content does not fall within the acceptable download parameters, it will eliminate the next lowest priority content, and continue with this process until the remaining content size is within the acceptable download size.

In the present invention, once the Delivery Scheduler function determines that the remaining content falls within the acceptable download size, it will calculate the difference between the acceptable download size and the actual size of the remaining content. If there is no difference, the Delivery Scheduler function will initiate the download process. If a difference is calculated, the Delivery Scheduler function will go to the previously eliminated content, in priority from the last eliminated to the first eliminated, and recover that content until the difference between the acceptable download size and the actual size of the remaining content is consumed or as nearly consumed as possible in light of the acceptable download size and remaining content. This process ensures that the consumer always receives the largest amount of content in the download.

The Delivery Scheduler function also allows for the delivery to a consumer's computer of updates and improvements to the software that controls the functions of the invention. Such downloads are either done separately so as to maximize the content that can be downloaded, or take priority over content being downloaded.

The Delivery Scheduler function, using the well known functions of the consumer's computer, determines whether the consumer is engaged in using the computer at the time of access and uses the history of recent logged activity and past history stored in the consumers' profile to determine the optimum time for the download and also examines Internet network to determine optimum time when bandwidth is available. An algorithm is applied to this information, which results in a command to either proceed with or delay the download.

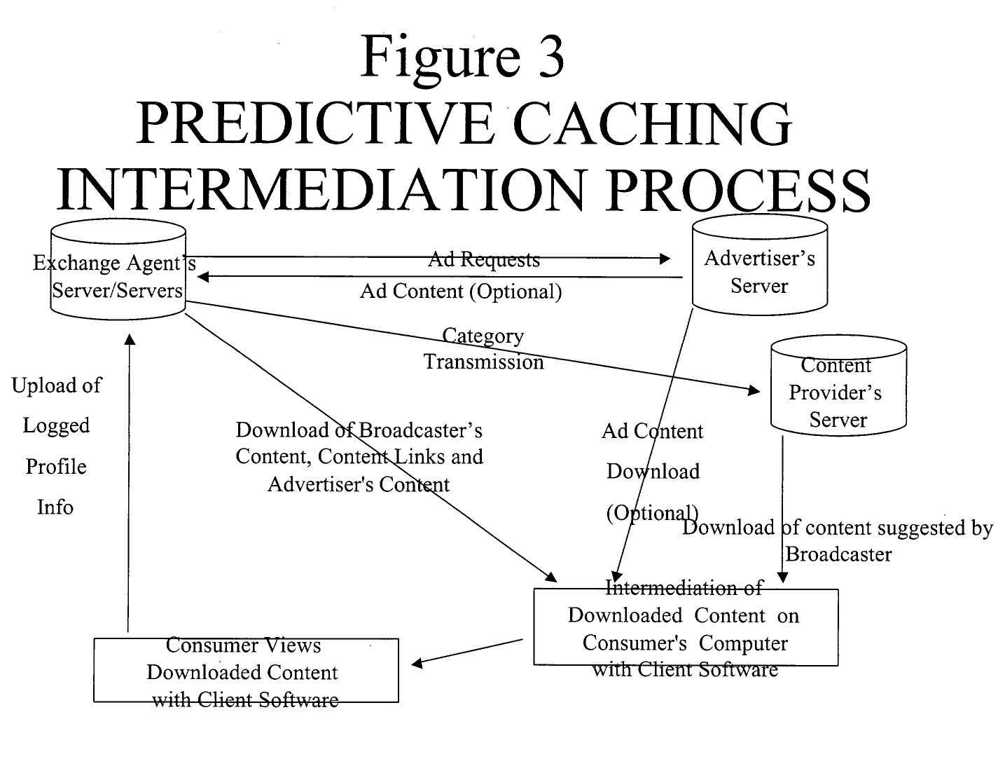

FIG. 3 shows various steps involved in a predictive caching function that may be utilized in the present invention. Predictive Caching, working in combination with The Delivery Scheduler function, is a method of nonlinear digital broadcasting of selected content and content links, the coordination of delivery of that content from disparate sources to, and the organization, control and presentation of selected content and selected content links on, a consumer's computer. Relying on standard and enhanced profiling techniques to select and download to a consumer's computer targeted content and content links from a Exchange Agent's server, the method also enables the Exchange Agent's server or servers to request from Advertiser's servers that Advertising Content that meets the perceived interests of the consumer (see FIG. 3). In addition, the Exchange Agent's server or severs downloads onto the consumer's computer links to Viewing or Listening Content that is perceived to be of interest to the Consumer. Those links are to targeted content from a separate and distinct Viewing Content Providers server. The method instructs the consumer's computer to both download content from the Viewing/Listening Content Provider's server and to organize the delivery of the content from an Exchange Agent's servers and Viewing Content from one or more Content Provider's servers. Once the downloading of all content is complete, the Content manager function organizes the content into a seamless presentation viewable on the consumer's computer in a preselected format.

If the download includes content from disparate servers, the Delivery Scheduler function sequentially requests downloads information from each of those servers to the consumer's hard drive, so that only one server at a time is downloading into the consumer's computer memory. FIG. 3 also shows the consumer/consumer's computer providing profile information to the exchange agent server or servers, which is used by that server to determine appropriate ads to sent to the user, as well as content obtained from a content provider's server. The downloaded content and/or ad information is provided to the user by way of the content manager function, which allows the user to view downloaded content by way of the client software.

The Content Manager Function.

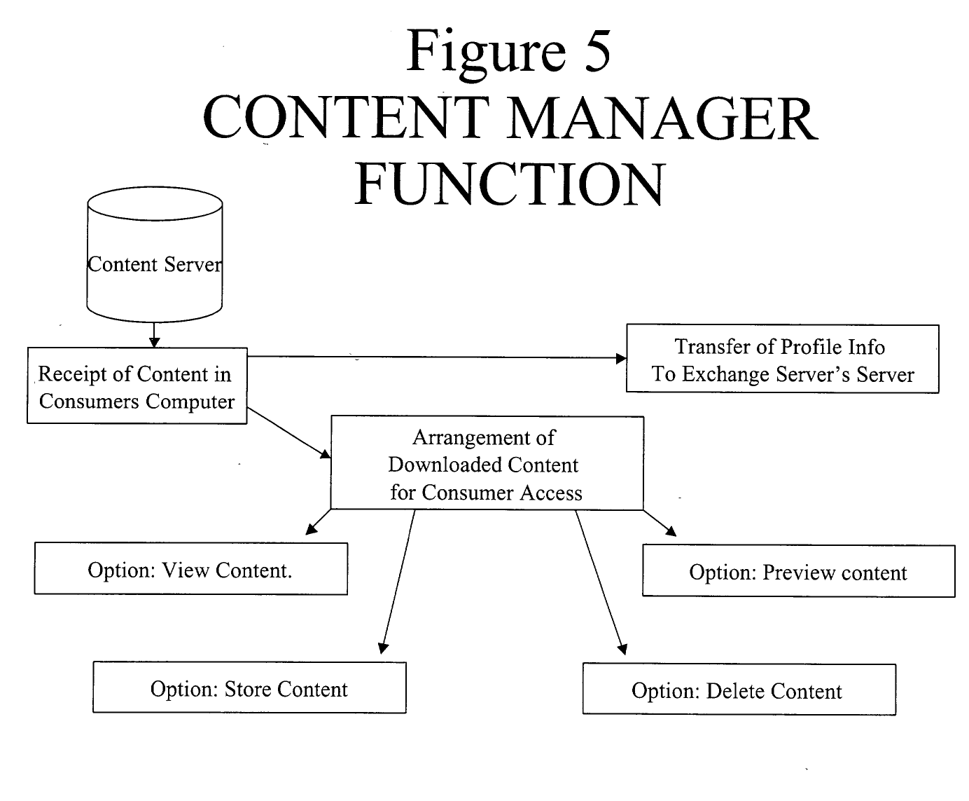

Another component in the preferred embodiment is the Content Manager function. Elements of the Content Manager function are shown in FIG. 5. The content manager function facilitates the receipt, storage and manipulation of the downloaded content once the consumer's computer receives it. This computer function accepts the proceed or delay download command from the Delivery Scheduler function, aggregates the selected content links processed by the profiling software, and initiates the download of that content via the Internet, using widely know methods for downloading of content from one sever on the Internet to another. In addition, the Content Manager notifies any affiliated Content Providers to download their selected content as directed by the results of the profiling process. The Content Manager then stores and organizes the delivered content on the Consumer's hard drive for display.

The content that is downloaded may appear to the consumer in one of several ways. The consumer may be presented with a description of the selected content and a hyperlink which, when clicked on by the consumer mouse or pointing device, directs the consumer's browser to that link, or the selected content may be fully downloaded, in the case of Ad Content or content of a smaller bandwidth. In addition, the consumer may be presented with “near-on-demand” formatted content (the download of a certain portion of lengthy content, such as a pay per view movie or webcast, whose selection to view triggers a showing of the downloaded portion of the content and simultaneous download of the remaining portion of the content or initiates downloading for future viewing). The present invention also enables the presentation of off-line referrals to content (such as concerts DVDs, audio CDs or contests). Referring now to FIG. 5, once the downloaded content has been arranged by the content manager function, the user is provided with several options: a) preview the content, b) view the content, c) store the content, d) delete the content or e) leave the content as delivered.

The present invention also enables the consumer to view a listing, or guide, of the delivered content accompanied by additional information regarding that content, and to control the viewing of the content, targeted messaging and advertising opportunities. The guide, unlike traditional, single technology, linear guides, displays Cross Technology content opportunities, such as DVD, and CD, CD-Rom, broadcast TV streaming, near-on-demand and on-demand Video, Music, audio, games and any other media capable of being played or displayed on a computer, as well as Advertising Content and E-Commerce opportunities. The guide integrates these disparate technologies into one seamless, digital entertainment guide for all uses.

In the process of the selection of content to be delivered, the Content Manager collects certain data regarding the content (“content data”), including but not limited to the type of content, category or genre, content title and other details, such as principal performers, run time and content provider. Additional content data such as delivery terms may also be collected. For example, content data information regarding a delivered pay-per-view encrypted movie, audio or music video will also include the view terms (pay-per-view price, period in which the content may be viewed, if limited, and time when the content will self delete), or the terms under which the consumer may indefinitely save the content. For example, this method enables copyright owners to place ownership, resale and distribution restrictions on the delivery, much the same as those, which accompany the traditional sale or rental of movies, videos and CDs/DVDs.

These different types of content must be managed differently (i.e. ensuring display perimeters, compliance with encryption guidelines and appropriate deletion of and selected content links once it is viewed or after a specific period of time).

In an embodiment of the invention, the content data is delivered to and formatted by a personalized content guide (PCG). This is a computer program, which collects the content data into a ticker type electronic programming guide format (“guide”), which enables the consumer to review, preview and otherwise customize the manner in which the guide displays the delivered content. The content data is set forth in any one of several formats; the consumer is able to select the desired format from any one of multiple supplied formats. The guide will, on the first download, display the information in a default format, which is the order of the consumer's perceived interest as delivered by The Delivery Scheduler function. When the consumer opens the guide, they will be prompted to review the format of the guide and be given an opportunity to select a default display format, in which case all future guides will be presented in that format. For instance, instead of the priority, or order, in which The Delivery Scheduler function delivers the content, the consumer may want to see all movies displayed first, or all audio selections displayed first. In addition, the method enables the consumer to switch between different formats whenever they are in the guide, whether or not a default format was selected.

The present invention enables the consumer to select one of several ways to view the guide and delivered content. For example, the consumer may choose to view the content displayed in the guide in a different format than the default format and may customize the guide by adding or subtracting categories or genres, and by bookmaking favorite content. The consumer may choose to preview previewable content, immediately view the content, save content that is allowed to be saved, or delete consent of no interest to the consumer. The present invention enables the consumer to preview or view the delivered content, or selected individual items of the delivered content, in any desired order by selecting the appropriate button displayed in the guide in the order the content is to be previewed/viewed. If the consumer makes more hard drive space available, the consumer may also initiate the delivery of lower priority content that was eliminated in the content selection process, in which case the Delivery Scheduler script will begin again as to that content. If the consumer takes no action regarding the content, it will remain on the consumer's computer, to be deleted according to the parameters set forth in the guide. The guide is then used to play whatever content the consumer selects amongst the downloaded content.

Navigation of the guide may be based on consumer-established preferences, profiling, genre/category, recommendation or any combination thereof. The method of navigation may be by traditional means such as keyboard or pointer device, or other means such as voice or 3D, or any method that permits control and selection of displayed items. The Guide may also be “skinnable” where consumers may select many alternative designs.

Depending on the type of content that is delivered, the consumer may be able to “Preview” the content, if previews are provided or allowed by the content provider. This method is implemented by the placing of a “Preview” button on the guide, or distinguishing the content (i.e. displaying the previewable content data in a distinguishing color, in the same manner that the color blue is used to denote a hyperlink on a web page).

The present invention also allows the user to select the content they want to preview or view, and the resulting selection opens a Universal Media Player (UMP). The method integrates the wide variety of media players now available (and can be modified to play future media types), such as streaming video plug-ins (QuickTime, Windows Media Player RealPlayer, etc.), DVD Player, TV/HDTV player and streaming music players (MP3) into what appears to the consumer as an integrated user interface with consistent navigation metaphors and controls (such as play, stop, forward, favorites, etc.). The consumer's selection is automatically detected and opens the media player required to play the type of media selected. If the Consumer activates the particular method implemented, the Guide will launch either a proprietary media player or any one of several widely distributed and well-known media player formats (such as Windows Media Player, RealPlayer or Apple's QuickTime Media Player), and display the preview of the content. For instance, if the content is a movie or video, the guide might play highlights of that content or a content provider supplied movie/video trailer may be shown. If the content is audio content, the guide might play highlights of the content, such as a portion of a musical piece or speech. These “teasers” would be used to encourage the consumer to play the previewed content, thereby increasing pay per views.

The present invention enables the Exchange Agent to deliver to the consumer additional content in the form of messages, Advertising Content and E-Commerce opportunities. Messages may contain such information regarding targeted announcements of deliverable content or E-Commerce opportunities, previews of available deliverable content, contest opportunities, upcoming events and e-commerce opportunities. Advertising Content and E-Commerce opportunities may also appear. Targeted messages are those that are have perceived interest to the consumer. Targeted announcements are more likely to be viewed by consumers, thereby increasing the chances of action taken by the consumer (i.e. purchase of pay per view content, viewing of ads, engaging in e-commerce). In addition, the method allows for the delivery of announcements about the service itself. For instance, The Delivery Scheduler function may initiate a notice that there is not enough drive space to deliver content at the next scheduled delivery, advising the consumer to make additional hard disk space available. The message may also make announcements of events such as software upgrades, new features and feature improvements and new content partners.

Use of targeted content delivery can result in both targeted delivery of Viewing Content (such as pay-per-view movies, music and other media) and Advertising content. For instance, the delivery of targeted Advertising Content to be viewed, the delivery of targeted e-commerce opportunities (on- or off-line opportunities to purchase products and services), and consumer participation activities (such as contests, drawings and other activities requiring more consumer involvement), in addition to all other standard methods for monetizing targeted audiences, can be implemented using standard techniques and the methods described herein to develop revenue sources.

Peer-to-Peer TV Broadcasting and Viewing

The streaming media industry, while achieving breakthroughs in technology, characterized by greater levels of compression, improved qualities of audio and video, has none-the-less failed at achieving certain standards of ubiquity and seamless operation such as is typical of legacy entertainment systems such as television and radio. Users until now have located then played web-based digital audio and video media through a web-based search, or a digital entertainment or streaming media portal, methods designed for desktop PC internet users. Users of MP3 digital audio files have found comparatively more convenient methods to locate, download, then play digital music, however even these methods are still focused on the desktop PC user and not optimized for the easy “sit-back” style of usage to which living room entertainment users are accustomed.

The result has been slowness in the adoption rates of newer forms of digital media such as digital video, digital audio and digital still photos “new media”, by the mainstream of entertainment users. The applicant believes slow adoption, in part, to be a consequence of user's frustrating or futile efforts to locate then play newer forms of digital audio and digital video. Users accustomed to a lifetime of instant access to television channels and radio stations teamed with the convenience of a remote control, expect their entertainment products to instantly deliver entertainment as they “surf” from a broad selection of choices.

Embodiments of the present invention may serve to bridge the gap between heavily entrenched traditional media usage behavior and new media usage by creating a delivery system that allows new media to be instantly served to the user in a fashion very similar to that which television and radio users are accustomed to. Application of the present invention results in instantaneous TV-like usability of newer forms of digital media such as digital video, digital audio and digital still photos. In addition, the application of the present invention provides a method for new media publication and distribution of a great body of media created and stored on users home systems at the “edge” of the internet including media created by other users, rather than the standard content creation industries. Content may also be user or community-created content (e.g., the “Mill Valley AYSO soccer video channel”) as well as ‘professional’ content (e.g., the “Snow boarding channel”) This way embodiments of the present invention may be used by a community to share their DV content with like-minded people.

An additional application of the present invention allows a server to perform identification, permission verification, scheduling and file transfer initiation functions that permit the secure and timely transfer of the Broadcast Segments. The resulting new media broadcasts in accordance with the present invention offer a true alternative to the commercial television and radio broadcasts.

Embodiments of the present invention provide for a system., method and computer program product for organizing, publishing and distributing (collectively “Broadcasting”), then locating, taking delivery, and displaying (collectively “Viewing”) new forms of digital media, such as digital audio, digital video, digital photos (collectively “New Media”) that aggregately result in seamless, easily navigable viewing and listening experience similar to that which a television currently provides. Involved may be at least two User operated computing devices on which reside the invention, which may be a software program (“the Program”) and at least one server (Master Agent). Users of the invention may be viewers and listeners of New Media (“Viewers”), or distributors of New Media (“Broadcasters”) (the Program allows one to be either a Viewer or a Broadcaster). Using a remote control to perform functions of the Program in an easy to navigate environment, Broadcasters may create a collection that includes one or more digital media types for broadcast using a variety of third-party applications such as are commonplace on the personal computer, or through special client software tools that allow the Broadcaster to select an organize digital media files in a chosen order, insert text or graphics or other similar objects, and to save and store that organized media (“Broadcast Segment”) and link it to a specific button on the user interface of the software program, which button is known as a “Channel, which operates as a residence for the Broadcast Segment. Included in this process may be a drag and drop assembly of media clips, the assigning of permissions (for example, without limitation, push/pull permissions, download scheduling, modification and distribution permissions). A Broadcast Segment may be an original collection of digital media clips or an update to a previously broadcast Segment.

Embodiments of the present invention may allow the Broadcaster to grant certain permissions to allow Viewers to view, and schedule the delivery of, the Broadcast Segment. Broadcasters can store and broadcast one or more Broadcast Segments into one or more Channels at a time. Viewers can be selected either individually or by interest group, work project group, community or organization or any other desired grouping. The organized media (“Broadcast Segment”) is then linked by the Broadcaster to a Broadcaster identified Channel”. The Broadcaster then initiates an Intention to transmit Notice, which is either sent to the Master Agent or, alternatively, can be sent directly to the Viewer. The on line/off line status of the Viewers computer is determined by the Master Agent, and if on line, the viewer is provided certain information about the Broadcast Segment, such as the Broadcaster's Name, size of the download, and the Broadcaster's description of the Broadcast Segment's content. The Viewer is then given the option to accept or refuse the download of the Broadcast Segment. Once the Broadcast Segment is downloaded, the program creates a Channel on the Viewer's computer that corresponds to the Broadcaster's selected Channel name. The Viewer may see one or more such Channels, depending on the number of previous downloads and the number of previous broadcasts initiated by the Viewer. The Viewer, using a remote control, can preview the Channels on the Viewers computer much like television viewers “surf” television broadcast channels. Channels are then selected for viewing. The Channels may be reflected in a Channel Guide, which provides information including, but not limited to, the Channel name, Channel identifier (either that provided by the Broadcaster or the Viewer), Broadcast Segment size and run time, download date and a certain amount of Viewer or Broadcaster discretionary information, such as a Broadcaster or Viewer selected description of the Broadcast Segment within the Channel.

The Viewer may select one or more channels, driven by the applicant's client server software, to view the Broadcast Segment. Viewers may store and queue Viewer-selected Broadcast Segments into one or more channels. The “surfing” experience may be enhanced by the implementation of a caching method on the Viewers computer that automatically inserts into the cache a predetermined portion of each channel, and the right of the Viewer to designate “active” channels (often viewed or new channels) and “inactive” (channels viewed less often, or channels the Viewer wishes to store”). Additional control may be given to Viewers to determine maximum cache and Channel size, download scheduling and the extent of storage media that is to be allocated to the download of Broadcast segments. In an embodiment of the present invention, the content stored in the cache may be of a format capable of being stored on various IP-addressable devices within a home network. For example, if digital photos, video or MP3s are stored on a user's desktop PC in the user's den, and the user wishes to watch or listen on to the content via their living room TV using a MSFT X-Box, Sony PS2 or Motorola/GI DCT5000 set-top, etc. all connected to a home network.

As an option, embodiments of the present invention may include some or all of the following characteristics and functions:

Broadcasters identify content they wish to broadcast (“Broadcast Segment”).

Broadcasters identify digital media clips already stored on their computer and organize them into a seamless continuous Broadcast Segment, and insertion of text, graphics and other objects and incorporation of them into a “Personal Channel”. Personal Channels may be organized by genre, family, interest, subject, project or any other classification.

Each “personal channel” would be given a name by the Broadcaster, and would have that same name on a Viewer's computing device one it was delivered.

Establishing Permissions using distribution lists, rights and schedulings. For instance, The Broadcaster may give the Viewers computing device-varying degrees of permission to further manipulate the Broadcast Segment, which rights could range between absolutely no right to manipulate the digital media to the same rights that the Broadcaster has.

Preparation for distribution utilizing web server technology.

Distribution would be by broadcasting versus basic web-publishing.

Broadcasters location and readiness are known by the Master Agent running on peer-to-peer server/router

Broadcasters and Viewers are known to the Master Agent by an optional alias or by a URL.

Broadcasters can select Viewers, schedule distribution and set permissions.

Viewers can select/reject Broadcasters and set scheduling.

Master Agent may act as tool to verify identity permissions granted, scheduling and to initiate a download command to the Broadcaster's computer.

The Broadcaster can elect to broadcast or “push” the Broadcast Segment to the Viewer, or may give to a Viewer the right to “pull” the channel to the Viewer's computer.

A Master Agent Server facilitates the broadcast

Peer to peer connections are established by the master agent in conjunction with a client agent running on both the Broadcaster's software and the Viewer's software.

A Broadcasting Agent communicates to the Master Agent, running on the Server, that it has a Broadcast Segment ready to go to one or more Viewers,

The Master Agent seeks out the selected Viewers, identified by alias, URL or other identifier, and verifies the on line/off line status and identity/granted permissions for that Viewer.

A Viewing Agent communicates to the Master Agent that it has an interest in some or all of the Broadcast Segment.

Upon identifying a Broadcaster ready to broadcast and a Viewer authorized and scheduled to receive that Broadcast the Master Agent establishes/initiates a peer-to-peer communications link between Broadcaster and Viewer on which the Broadcast Segment from the Broadcaster's system is sent to and stored on the hard-drive or caching mechanism on the Viewer's system.

The Broadcast Segment and identifying Channel are transferred to the recipient Viewer's computing device.

The resulting Broadcast can occur in the background behind other foreground activities.

Optionally, the Broadcast can utilize only excess bandwidth so as to not impact on the quality of other functions running in the foreground.

Optionally, error checking insures completeness of transmissions. As a further option, error checking may insert an “incomplete” programming message in cases where a Broadcast is not fully received by the Viewer's system. As an additional option, a Broadcast can continue through to completion even after interruption or reboot.

Viewers select one or more Personal Channels to View the Broadcast Segment

A function of the client software (Viewer Agent) offers one or more television-like “channels” from in which the Viewer may store and queue digital materials sent to the Viewer by the Broadcaster.

The client software has “channel” controls allowing the consumer to select and switch between different “personal channels”. And, depending on the permissions given, manipulate the digital media in any “personal channel”, and to provide permissions for the further delivery of or accessibility to the channel media by one or more preselected recipient Viewers or group of persons who fit a certain profile or are identified as belonging to a certain group.

A Viewer may also elect to rearrange or interlace comments into a Broadcast Segment and rebroadcast the modified Broadcast Segment to the original Broadcaster or group to whom the original broadcast was made.

Creating a Television-like New Media Channel for the Viewer

Embodiments of the present invention may extend television-like attributes to viewing of Broadcast Segments that viewers of television expect from a television such as:

Easy to use controls/remote control,

Broadcast Segments organized into a “channel” structure,

the Viewer's ability to instantly select programming through a channel guide/navigator,

instant playback when selected by a Viewer,

continuous or “seamless” playback of Media files in a Broadcast Segment.

A content-selection engine, such as a Universal Media Player engine, instantly plays digital audio and digital video content

Instant television-like playback maybe made possible by a Media Player engine, such as the Universal Media Player (UMP) engine manufactured by Lumenati, Inc., or by other engines made by other companies that allow one to receive and play digital audio and/or digital video content from a network such as the Internet. The UMP is a hand-held remote control device that allows various selections to be made by a Viewer so as to retrieve content by way of a computer (and monitor) utilized by Viewer, whereby the content is retrieved from a network such as the Internet.

The present invention utilizes the UMP or other suitable engine to power the playback of the Broadcast Segment, whereby the UMP is operated by the Viewer.

Once loaded into memory, the engine allows instant media selections and playback without any lag time such as is normally experienced by the user when moving between dissimilar forms of media.

The resulting changes from one program to the next occur in a very short period of time, such as in a fraction of one second.

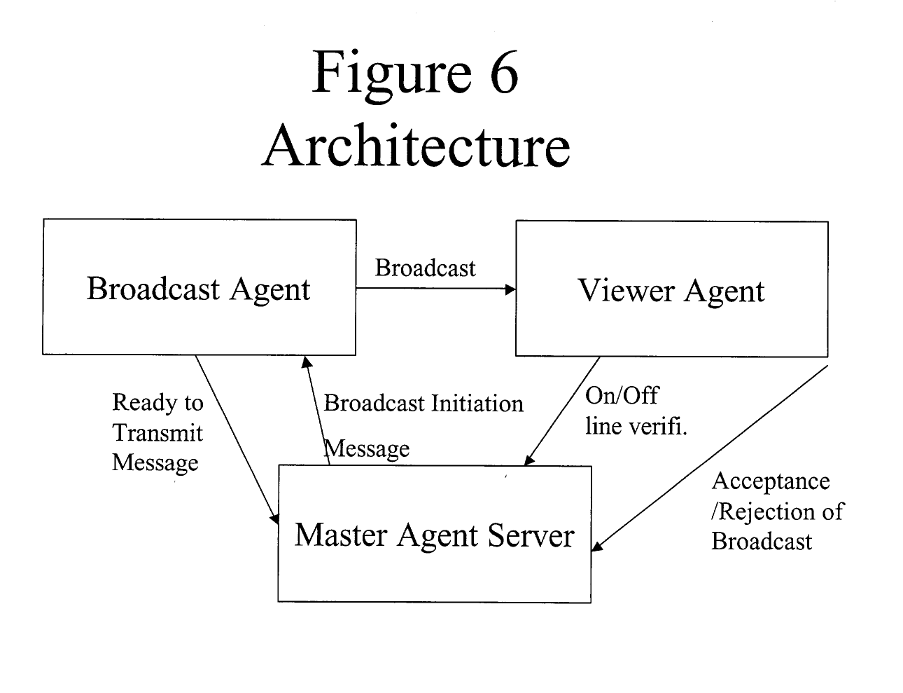

FIG. 6 shows an architecture that includes a Broadcast Agent operating at a remote device, a Viewer Agent operating at another remote device, and a Master Agent which is operating on a server in accordance with an embodiment of the present invention. The Broadcast Agent, Viewer Agent and Master Agent are communicatively connected to each other by way of a network, such as by way of the Internet. The Broadcast Agent, the Master Agent, and the Viewer Agent are software applications running on computers at the Broadcaster, the Server, and the Viewer, respectively.

The Broadcast Agent sends an Intent to Broadcast signal to the Master Agent Server. That signal can alternatively also be sent directly to the Viewer Agent as well. The Viewer Agent is presented with an option to accept the content to be provided by the Broadcast Agent, and if the Viewer Agent desires to accept the content, it will send an Acceptance of Broadcast signal to the Master Agent. If it does not desire to accept the content, it will send a Rejection of Broadcast signal to the Master Agent. If the Master Agent receives the Acceptance of Broadcast signal from the Viewer Agent, the Master Agent Server responds by sending a Broadcast Initiation signal to the Broadcast Agent, and then the Broadcast Agent can start to send content, as a Broadcast Segment, to the Viewer Agent. Also shown in FIG. 6 is an On/Off Line Verification for the Viewer Agent to notify the Master Agent when it is operating.

In a “pull” configuration of information transfer between a Broadcaster and a Viewer, the Viewer agent is presented with a menu of various content provided by various Broadcasters. When a Viewer desires to viewer content provided by a specific Broadcaster, it notifies the Master Agent by way of a menu selection made by the Viewer on a monitor of a computer operated by the Viewer. The Viewer Agent presents the menu to the Viewer, and also presents the menu selection to the Master Agent. The Master Agent then sets up a peer-to-peer content transmission between the specific Broadcaster and the Viewer.

In a “push” configuration of information transfer between a Broadcaster and a Viewer, the Viewer is presented with an Intent to Broadcast Notification sent directly from the Broadcast, Agent. If the Viewer desires to receive the content, it makes a selection on a menu presented on the monitor of the computer operated by the Viewer, and the Viewer Agent notifies the Master Agent of this selection. The Master Agent then sets up a peer-to-peer content transmission between the Broadcaster and the Viewer.

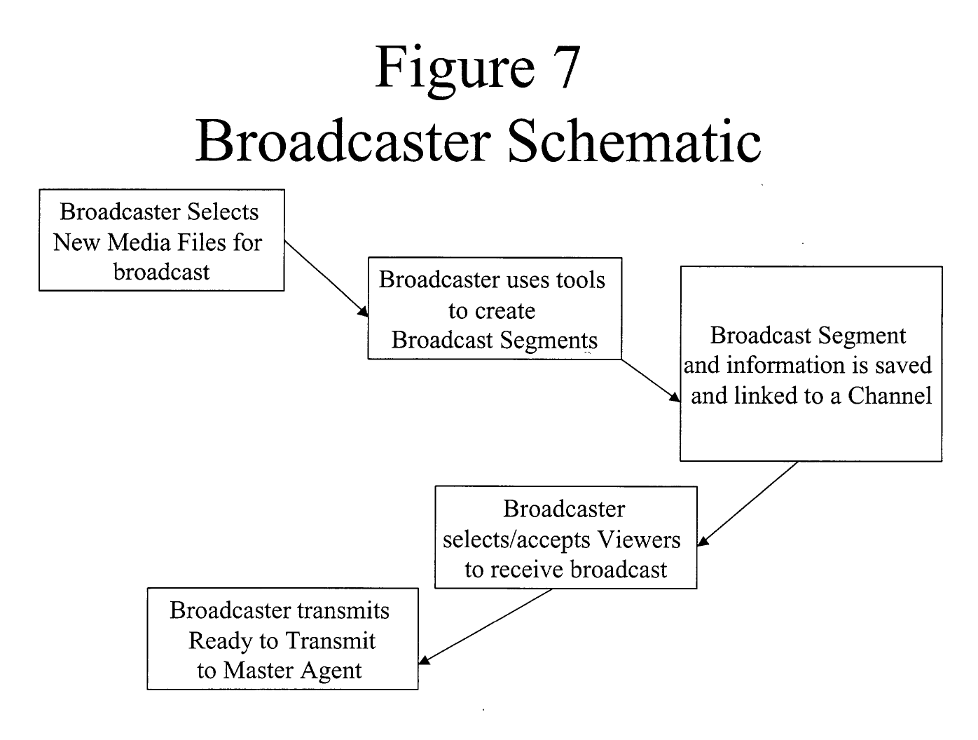

FIG. 7 shows a schematic of the Broadcast Agent functions in accordance with an embodiment of the present invention. The Broadcaster selects files, such as New Media files, streaming video and/or streaming audio, for broadcast. The Broadcaster, uses software tools to create Broadcast Segments, in a manner known to those skilled in the art. The Broadcast Segments are saved with a link to a Broadcast Channel. The Broadcaster selects/accepts Viewers to receive broadcasts. For example, the Broadcaster can select only Viewers of a particular age category, if the Broadcast Segments are of a mature nature. The Broadcaster transmits Intent to Broadcast signals to the Master Agent (or alternatively also to the Viewer Agent).

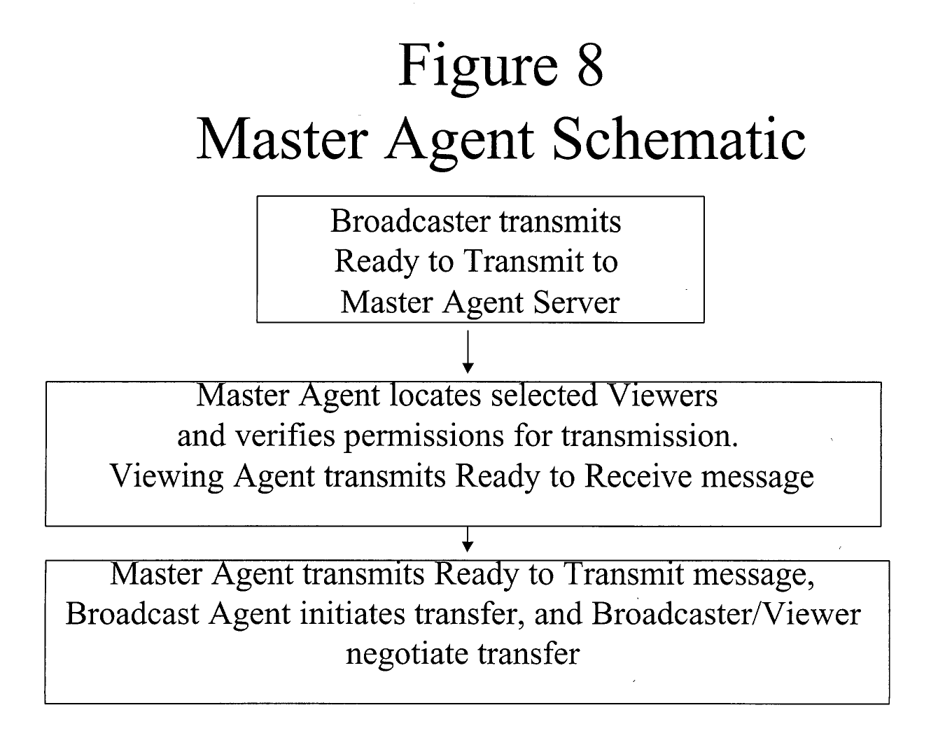

FIG. 8 shows a schematic of the Master Agent functions in accordance with an embodiment of the present invention. The Master Agent receives Intent to Broadcast signals sent from the Broadcaster Agent. The Master Agent perceives/processes transmission, locates selected Viewers, and seeks approval for transmission from the Viewer Agent. The Viewer Agent receives an Intent to Broadcast Notification, sent by the Master Agent and/or sent directly from the Broadcaster Agent.

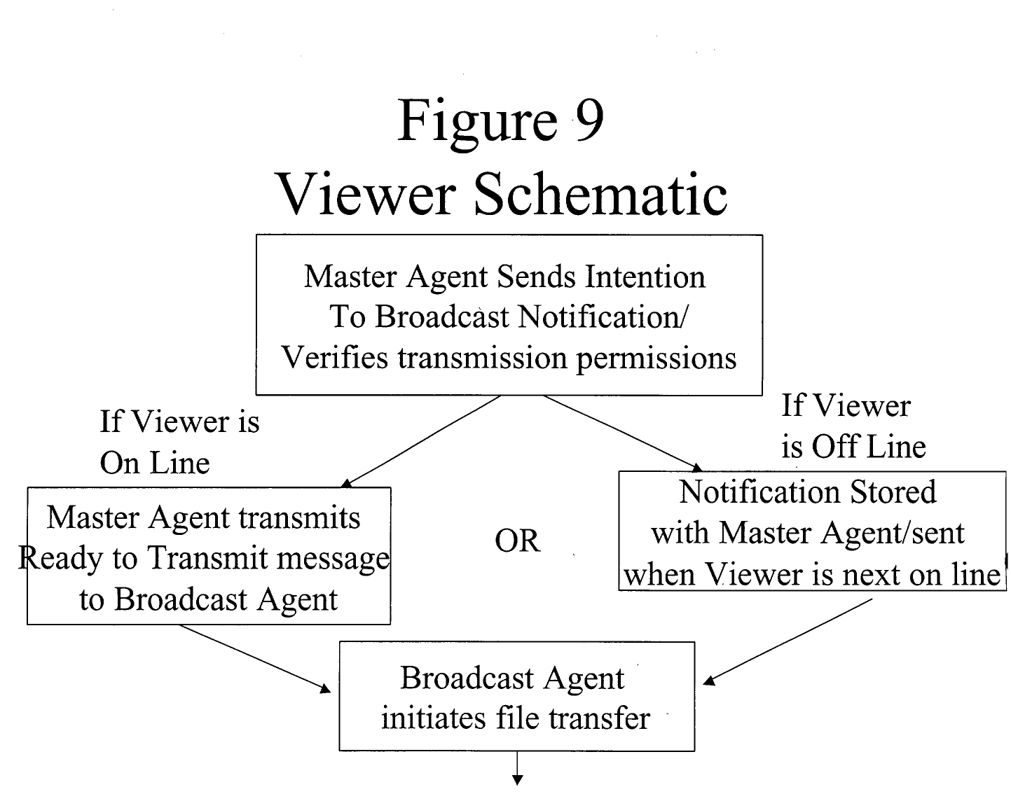

FIG. 9 shows a schematic of the Viewer Agent functions in accordance with an embodiment of the present invention. As explained above with reference to FIG. 8, the Master Agent sends Intent to Broadcast Notification and verifies transmission permissions. If the Viewer is On-Line, the Viewer is notified of the Intent to Broadcast, as output by the Master Agent. If the Viewer is Off-Line, the Intent to Broadcast Notification is stored with the Master Agent for future notification to the Viewer Agent (that is, when the Viewer Agent goes back On-Line). In either case, when the Viewer Agent is On-Line, it is given the option to view, store, or refuse the Broadcast (as output by the Broadcaster Agent).

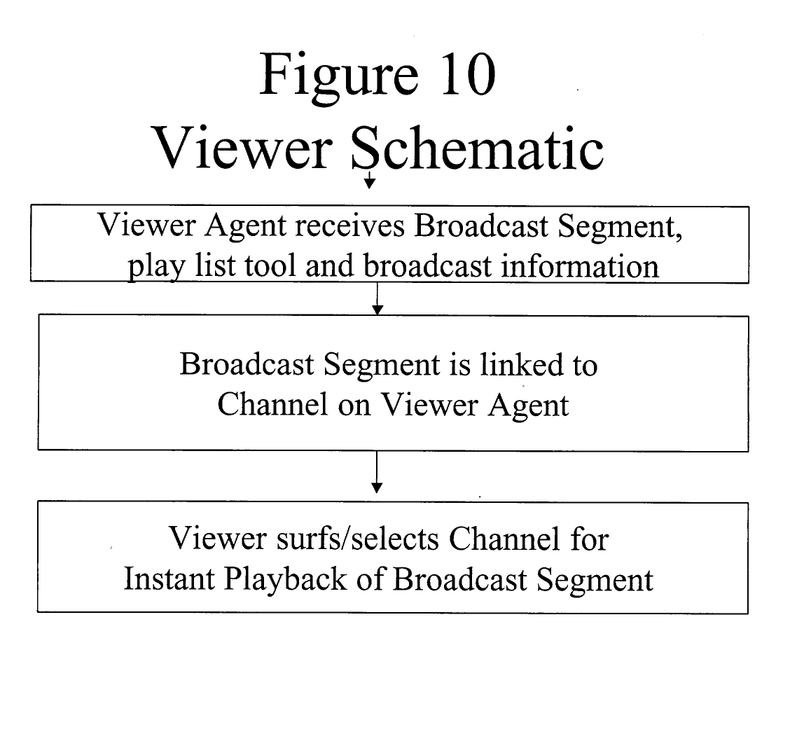

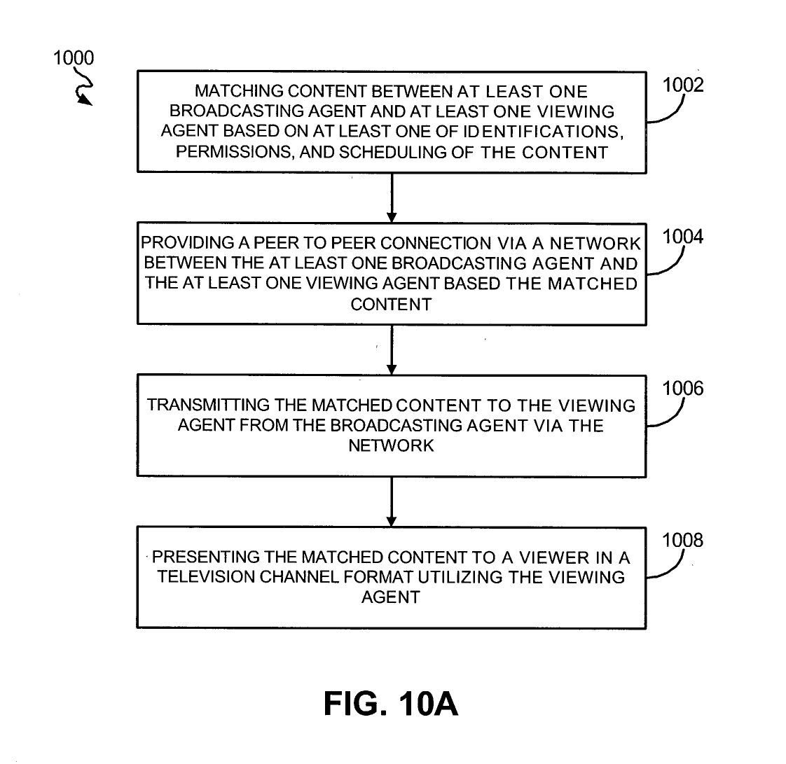

FIG. 10 shows a schematic of additional functions of the Viewer Agent. If the Viewer desires to obtain the Broadcast, the Viewer chooses to view or store the Broadcast (by selecting menu choices presented on a monitor used by the Viewer, as presented by the Viewer Agent). The Master Agent receives this information, and advises the Broadcast Agent accordingly, and the content download is initiated as a peer-to-peer data transfer between the Broadcast Agent and the Viewer Agent. The Viewer Agent receives the Broadcast, and views or stores it by way of the Viewer Agent.

FIG. 10A is a flowchart of a process 1000 for delivering content utilizing a master agent in accordance with an embodiment of the present invention. Content between at least one broadcasting agent and at least one viewing agent is matched based on identifications, permissions, and/or scheduling of the content in operation 1002. A peer to peer connection is provided via a network between at least one broadcasting agent and at least one viewing agent based the matched content in operation 1004. The matched content is transmitted to the viewing agent from the broadcasting agent via the network in operation 1006. The matched content is presented by the viewing agent to a viewer in a television channel format in operation 1008.

In an embodiment of the present invention, the permissions and/or scheduling of the content may be assigned by the broadcasting agent. In another embodiment of the present invention, the matched content may be pulled from the broadcasting agent by the viewing agent. As another option, the matched content may be pushed by the broadcasting agent to the viewing agent. In yet another embodiment of the present invention, the broadcast agent may organize the content into broadcast segments and link the broadcast segments to one or more channels in the television viewing format. In such an embodiment, the matched content includes at least one broadcast segment and the viewer selects one of the channels to view the broadcast segment of the matched content. In even another embodiment, information about the viewer's use of a computer and of any connected peripherals to the computer may be collected and wherein the collected information may be used to provide content choices to the viewer provided via at least one of the network and any one of the connected peripherals.

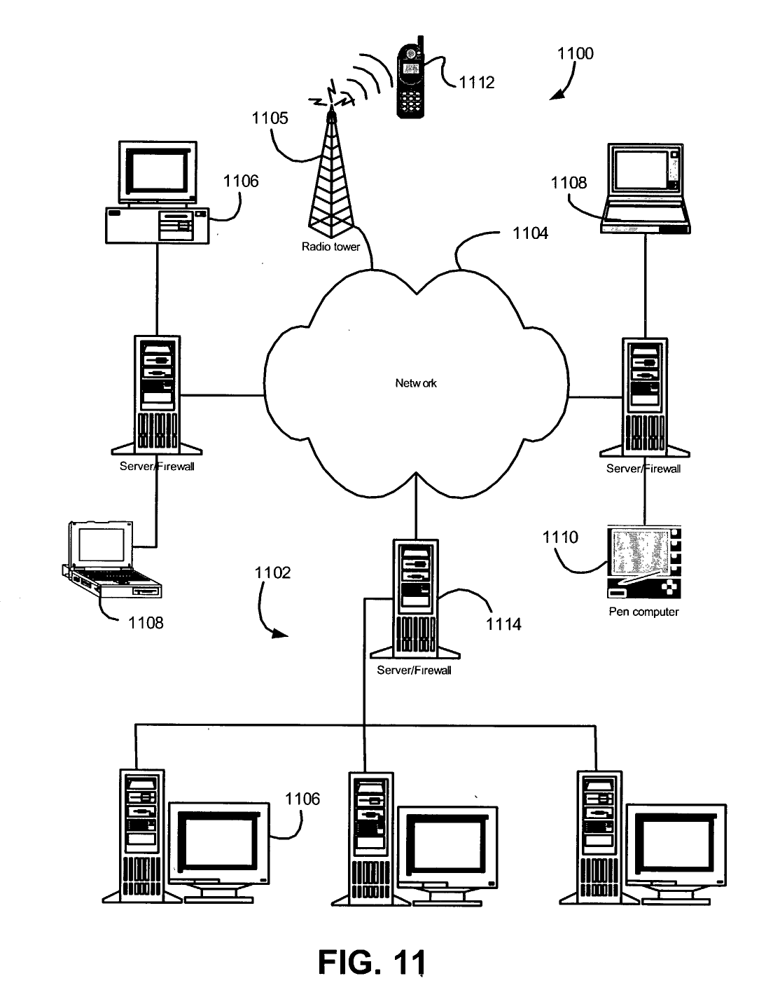

FIG. 11 illustrates an exemplary network system 1100 with a plurality of components 1102 in accordance with one embodiment of the present invention. As shown, such components include a network 1104 which take any form including, but not limited to a local area network, a wide area network such as the Internet, and a wireless network 1105. Coupled to the network 1104 is a plurality of computers which may take the form of desktop computers 1106, lap-top computers 1108, hand-held computers 1110 (including wireless devices 1112 such as wireless PDA's or mobile phones), or any other type of computing hardware/software. As an option, the various computers may be connected to the network 1104 by way of a server 1114 which may be equipped with a firewall for security purposes. It should be noted that any other type of hardware or software may be included in the system and be considered a component thereof.

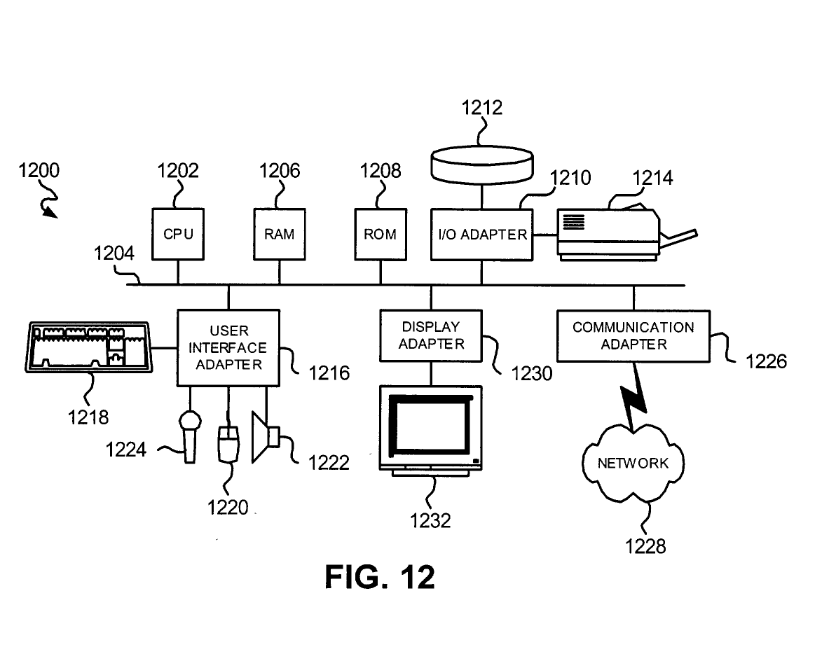

A representative hardware environment associated with the various components of FIG. 11 is depicted in FIG. 12. In the present description, the various sub-components of each of the components may also be considered components of the system. For example, particular software modules executed on any component of the system may also be considered components of the system. In particular, FIG. 12 illustrates an exemplary hardware configuration of a workstation 1200 having a central processing unit 1202, such as a microprocessor, and a number of other units interconnected via a system bus 1204.

The workstation shown in FIG. 12 includes a Random Access Memory (RAM) 1206, Read Only Memory (ROM) 1208, an I/O adapter 1210 for connecting peripheral devices such as, for example, disk storage units 1212 and printers 1214 to the bus 1204, a user interface adapter 1216 for connecting various user interface devices such as, for example, a keyboard 1218, a mouse 1220, a speaker 1222, a microphone 1224, and/or other user interface devices such as a touch screen or a digital camera to the bus 1204, a communication adapter 1226 for connecting the workstation 1200 to a communication network 1228 (e.g., a data processing network) and a display adapter 1230 for connecting the bus 1204 to a display device 1232. The workstation may utilize an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

An embodiment of the present invention may also be written using Java, C, and the C++ language and utilize object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain: They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. An embodiment of the invention utilizes HyperText Markup Language (HTML) to implement documents on the Internet together with a general-purpose secure communication protocol for a transport medium between the client and the server. HTTP or other protocols could be readily substituted for HTML without undue experimentation. Information on these products is available in T. Berners-Lee, D. Connoly, “RFC 1866: Hypertext Markup Language—2.0” (November 1995); and R. Fielding, H, Frystyk, T. Berners-Lee, J. Gettys and J. C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystems's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets”(e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.”Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.”Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

JavaScript is an interpreted programming or script language from Netscape. It is somewhat similar in capability to Microsoft's Visual Basic, Sun's Tcl, the UNIX-derived Perl, and IBM's REX. In general, script languages are easier and faster to code in than the more structured and compiled languages such as C and C++. JavaScript is used in Web site development to do such things as: automatically change a formatted date on a Web page; cause a linked-to page to appear in a popup window; and cause text or a graphic image to change during a mouse rollover.

JavaScript uses some of the same ideas found in Java. JavaScript code can be imbedded in HTML pages and interpreted by the Web browser (or client). JavaScript can also be run at the server as in Microsoft's Active Server Pages before the page is sent to the requestor. Both Microsoft and Netscape browsers support JavaScript.

Another technology that provides similar function to Java is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.”ActiveX Technologies also includes ActiveX Server Framework, allowing developers to create server applications. One of ordinary skill in the art readily recognizes that ActiveX could be substituted for Java without undue experimentation to practice the invention.

A technology of Active X is the component object model (COM). Used in a network with a directory and additional support, COM becomes the distributed component object model (DCOM). The main thing that you create when writing a program to run in the ActiveX environment is a component, a self-sufficient program that can be run anywhere in your ActiveX network. This component is known as an ActiveX control. ActiveX is Microsoft's answer to the Java technology from Sun Microsystems. An ActiveX control is roughly equivalent to a Java applet.

OCX stands for “Object Linking and Embedding control.” Object Linking and Embedding (OLE) was Microsoft's program technology for supporting compound documents such as the Windows desktop. The Component Object Model now takes in OLE as part of a larger concept. Microsoft now uses the term “ActiveX control” instead of “OCX” for the component object.

An advantage of a component is that it can be re-used by many applications (referred to as component containers). A COM component object (ActiveX control) can be created using one of several languages or development tools, including C++ and Visual Basic, or PowerBuilder, or with scripting tools such as VBScript.

Transmission Control Protocol/Internet Protocol (TCP/IP) is a basic communication language or protocol of the Internet. It can also be used as a communications protocol in the private networks called intranet and in extranet. When you are set up with direct access to the Internet, your computer is provided with a copy of the TCP/IP program just as every other computer that you may send messages to or get information from also has a copy of TCP/IP.

TCP/IP is a two-layering program. The higher layer, Transmission Control Protocol (TCP), manages the assembling of a message or file into smaller packet that are transmitted over the Internet and received by a TCP layer that reassembles the packets into the original message. The lower layer, Internet Protocol (IP), handles the address part of each packet so that it gets to the right destination. Each gateway computer on the network checks this address to see where to forward the message. Even though some packets from the same message are routed differently than others, they'll be reassembled at the destination.

TCP/IP uses a client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received.).

Many Internet users are familiar with the even higher layer application protocols that use TCP/IP to get to the Internet. These include the World Wide Web's Hypertext Transfer Protocol (HTTP), the File Transfer Protocol (FTP), Telnet which lets you logon to remote computers, and the Simple Mail Transfer Protocol (SMTP). These and other protocols are often packaged together with TCP/IP as a “suite.”

Personal computer users usually get to the Internet through the Serial Line Internet Protocol (SLIP) or the Point-to-Point Protocol. These protocols encapsulate the IP packets so that they can be sent over a dial-up phone connection to an access provider's modem.

Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Internetwork Packet Exchange (IPX)is a networking protocol from Novell that interconnects networks that use Novell's NetWare clients and servers. IPX is a datagram or packet protocol. IPX works at the network layer of communication protocols and is connectionless (that is, it doesn't require that a connection be maintained during an exchange of packets as, for example, a regular voice phone call does).

Packet acknowledgment is managed by another Novell protocol, the Sequenced Packet Exchange (SPX). Other related Novell NetWare protocols are: the Routing Information Protocol (RIP), the Service Advertising Protocol (SAP), and the NetWare Link Services Protocol (NLSP).

A virtual private network (VPN) is a private data network that makes use of the public telecommunication infrastructure, maintaining privacy through the use of a tunneling protocol and security procedures. A virtual private network can be contrasted with a system of owned or leased lines that can only be used by one company. The idea of the VPN is to give the company the same capabilities at much lower cost by using the shared public infrastructure rather than a private one. Phone companies have provided secure shared resources for voice messages. A virtual private network makes it possible to have the same secure sharing of public resources for data.

Using a virtual private network involves encryption data before sending it through the public network and decrypting it at the receiving end. An additional level of security involves encrypting not only the data but also the originating and receiving network addresses. Microsoft, 3Com, and several other companies have developed the Point-to-Point Tunneling Protocol (PPP) and, Microsoft has extended Windows NT to support it. VPN software is typically installed as part of a company's firewall server.

Wireless refers to a communications, monitoring, or control system in which electromagnetic radiation spectrum or acoustic waves carry a signal through atmospheric space rather than along a wire. In most wireless systems, radio frequency (RF) or infrared transmission (IR) waves are used. Some monitoring devices, such as intrusion alarms, employ acoustic waves at frequencies above the range of human hearing.

Early experimenters in electromagnetic physics dreamed of building a so-called wireless telegraph. The first wireless telegraph transmitters went on the air in the early years of the 20th century. Later, as amplitude modulation (AM) made it possible to transmit voices and music via wireless, the medium came to be called radio. With the advent of television, fax, data communication, and the effective use of a larger portion of the electromagnetic spectrum, the original term has been brought to life again.

Common examples of wireless equipment in use today include the Global Positioning System, cellular telephone phones and pagers, cordless computer accessories (for example, the cordless mouse), home-entertainment-system control boxes, remote garage-door openers, two-way radios, and baby monitors. An increasing number of companies and organizations are using wireless LAN. Wireless transceivers are available for connection to portable and notebook computers, allowing Internet access in selected cities without the need to locate a telephone jack. Eventually, it will be possible to link any computer to the Internet via satellite, no matter where in the world the computer might be located.

Bluetooth is a computing and telecommunications industry specification that describes how mobile phones, computers, and personal digital assistants (PDA's) can easily interconnect with each other and with home and business phones and computers using a short-range wireless connection. Each device is equipped with a microchip transceiver that transmits and receives in a previously unused frequency band of 2.45 GHz that is available globally (with some variation of bandwidth in different countries). In addition to data, up to three voice channels are available. Each device has a unique 48-bit address from the IEEE 802 standard. Connections can be point-to-point or multipoint. The maximum range is 10 meters. Data can be presently be exchanged at a rate of 1 megabit per second (up to 2 Mbps in the second generation of the technology). A frequency hop scheme allows devices to communicate even in areas with a great deal of electromagnetic interference. Built-in encryption and verification is provided.

Encryption is the conversion of data into a form, called a ciphertext, that cannot be easily understood by unauthorized people. Decryption is the process of converting encrypted data back into its original form, so it can be understood.

The use of encryption/decryption is as old as the art of communication. In wartime, a cipher, often incorrectly called a “code,”can be employed to keep the enemy from obtaining the contents of transmissions (technically, a code is a means of representing a signal without the intent of keeping it secret; examples are Morse code and ASCII). Simple ciphers include the substitution of letters for numbers, the rotation of letters in the alphabet, and the “scrambling” of voice signals by inverting the sideband frequencies. More complex ciphers work according to sophisticated computer algorithm that rearrange the data bits in digital signals.

In order to easily recover the contents of an encrypted signal, the correct decryption key is required. The key is an algorithm that “undoes” the work of the encryption algorithm. Alternatively, a computer can be used in an attempt to “break” the cipher. The more complex the encryption algorithm, the more difficult it becomes to eavesdrop on the communications without access to the key.

Rivest-Shamir-Adleman (RSA) is an Internet encryption and authentication system that uses an algorithm developed in 1977 by Ron Rivest, Adi Shamir, and Leonard Adleman. The RSA algorithm is a commonly used encryption and authentication algorithm and is included as part of the Web browser from Netscape and Microsoft. It's also part of Lotus Notes, Intuit's Quicken, and many other products. The encryption system is owned by RSA Security.

The RSA algorithm involves multiplying two large prime numbers (a prime number is a number divisible only by that number and 1) and through additional operations deriving a set of two numbers that constitutes the public key and another set that is the private key. Once the keys have been developed, the original prime numbers are no longer important and can be discarded. Both the public and the private keys are needed for encryption /decryption but only the owner of a private key ever needs to know it. Using the RSA system, the private key never needs to be sent across the Internet.

The private key is used to decrypt text that has been encrypted with the public key. Thus, if I send you a message, I can find out your public key (but not your private key) from a central administrator and encrypt a message to you using your public key. When you receive it, you decrypt it with your private key. In addition to encrypting messages (which ensures privacy), you can authenticate yourself to me (so I know that it is really you who sent the message) by using your private key to encrypt a digital certificate. When I receive it, I can use your public key to decrypt it.

A pop-up is a graphical user interface (GUI) display area, usually a small window, that suddenly appears (“pops up”) in the foreground of the visual interface. Pop-ups can be initiated by a single or double mouse click or rollover (sometimes called a mouseover), and also possibly by voice command or can simply be timed to occur. A pop-up window is usually smaller than the background window or interface; otherwise, it is may be called a replacement interface.

On the World Wide Web, JavaScript (and less commonly Java applets) may be used to create interactive effects including pop-up and full overlay windows. A menu or taskbar pulldown can be considered a form of pop-up. So can the little message box you get when you move your mouse over taskbars in many PC applications.

Plug-in applications are programs that can easily be installed and used as part of your Web browser. Initially, the Netscape browser allowed you to download, install, and define supplementary programs that played sound or motion video or performed other functions. These were called helper applications. However, these applications run as a separate application and require that a second window be opened. A plug-in application is recognized automatically by the browser and its function is integrated into the main HTML file that is being presented.

A browser is an application program that provides a way to look at and interact with all the information on the World Wide Web. The word “browser” seems to have originated prior to the Web as a generic term for user interfaces that let you browse (navigate through and read) text files online. By the time the first Web browser with a GUI was generally available (Mosaic, in 1993), the term seemed to apply to Web content, too. Technically, a Web browser may be considered a client program that uses the Hypertext Transfer Protocol (HTTP) to make requests of Web servers throughout the Internet on behalf of the browser user. Many of the user interface features in Mosaic, however, went into the first widely-used browser, Netscape Navigator. Microsoft followed with its Microsoft Internet Explorer. Lynx is a text-only browser for UNIX shell and VMS users. Another browser is Opera. While some browsers also support e-mail (indirectly through e-mail Web sites) and the File Transfer Protocol (FTP), a Web browser may not be required for those Internet protocols and more specialized client programs are more popular.

The Secure Sockets Layer (SSL) is a commonly-used protocol for managing the security of a message transmission on the Internet. SSL has recently been succeeded by Transport Layer Security (TLS), which is based on SSL. SSL uses a program layer located between the Internet's Hypertext Transfer Protocol (HTTP) and Transport Control Protocol (TCP) layers. SSL is included as part of both the Microsoft and Netscape browsers and most Web server products. Developed by Netscape, SSL also gained the support of Microsoft and other Internet client/server developers as well and became the de facto standard until evolving into Transport Layer Security. The “sockets” part of the term refers to the sockets method of passing data back and forth between a client and a server program in a network or between program layers in the same computer. SSL uses the public-and-private key encryption system from RSA, which also includes the use of a digital certificate.

TLS and SSL are an integral part of most Web browsers (clients) and Web servers. If a Web site is on a server that supports SSL, SSL can be enabled and specific Web pages can be identified as requiring SSL access. Any Web server can be enabled by using Netscape's SSLRef program library which can be downloaded for noncommercial use or licensed for commercial use. TLS and SSL are not interoperable. However, a message sent with TLS can be handled by a client that handles SSL but not TLS.

A SSL protocol is described in the SSL Protocol Version 3.0 by the Transport Layer Security Working Group, Nov. 18, 1996 for providing communications privacy over the Internet and allowing client/server applications to communicate in a way that is designed to prevent eavesdropping, tampering, or message forgery, the disclosure of which is incorporated herein by reference in its entirety.

Transport Layer Security (TLS) is a protocol that ensures privacy between communicating applications and their users on the Internet. When a server and client communicate, TLS ensures that no third party may eavesdrop or tamper with any message. TLS is a successor to the Secure Sockets Layer (SSL). TLS is composed of two layers: the TLS Record Protocol and the TLS Handshake Protocol. The TLS Record Protocol provides connection security with some encryption method such as the Data Encryption Standard (DES). The TLS Record Protocol can also be used without encryption. The TLS Handshake Protocol allows the server and client to authenticate each other and to negotiate an encryption algorithm and cryptographic keys before data is exchanged. The TLS protocol is based on Netscape's SSL 3.0 protocol; however, TLS and SSL are not interoperable. The TLS protocol does contain a mechanism that allows TLS implementation to back down to SSL 3.0. A TLS protocol is described in the document entitled, “The TLS Protocol, Version 1” by the Network Working Group of the Internet Society, 1999, the disclosure of which is incorporated herein by reference in its entirety. This document specifies Version 1.0 of the Transport Layer Security (TLS) protocol. The TLS protocol provides communications privacy over the Internet. The protocol allows client/server applications to communicate in a way that is designed to prevent eavesdropping, tampering, or message forgery.

Wireless Transport Layer Security (WTLS) is the security level for Wireless Application Protocol (WAP) applications. Based on Transport Layer Security (TLS) v1.0 (a security layer used in the Internet, equivalent to Secure Socket Layer 3.1), WTLS was developed to address the problematic issues surrounding mobile network devices—such as limited processing power and memory capacity, and low bandwidth—and to provide adequate authentication, data integrity, and privacy protection mechanisms.

Wireless transactions, such as those between a user and their bank, require stringent authentication and encryption to ensure security to protect the communication from attack during data transmission. Because mobile networks do not provide end-to-end security, TLS had to be modified to address the special needs of wireless users. Designed to support datagrams in a high latency, low bandwidth environment, WTLS provides an optimized handshake through dynamic key refreshing, which allows encryption keys to be regularly updated during a secure session.

The Wired Equivalent Privacy (WEP) algorithm, is part of the 802.11 standard. The 802.11 standard describes the communication that occurs in wireless local area networks (LANs). The Wired Equivalent Privacy (WEP) algorithm is used to protect wireless communication from eavesdropping. A secondary function of WEP is to prevent unauthorized access to a wireless network; this function is not an explicit goal in the 802.11 standard, but it is frequently considered to be a feature of WEP. WEP relies on a secret key that is shared between a mobile station (e.g. a laptop with a wireless Ethernet card) and an access point (i.e. a base station). The secret key is used to encrypt packets before they are transmitted, and an integrity check is used to ensure that packets are not modified in transit. The standard does not discuss how the shared key is established. In practice, most installations use a single key that is shared between all mobile stations and access points.

Peer-to-peer is a communications model in which each party has the same capabilities and either party can initiate a communication session. Other models with which it might be contrasted include the client/server model and the master/slave model. In some cases, peer-to-peer communications is implemented by giving each communication node both server and client capabilities. In recent usage, peer-to-peer has come to describe applications in which users can use the Internet to exchange files with each other directly or through a mediating server.

IBM's Advanced Peer-to-Peer Networking (APPN) is an example of a product that supports the peer-to-peer communication model.

On the Internet, peer-to-peer (referred to as P2P) is a type of transient Internet network that allows a group of computer users with the same networking program to connect with each other and directly access files from one another's hard drives. Napster and Gnutella are examples of this kind of peer-to-peer software. Corporations are looking at the advantages of using P2P as a way for employees to share files without the expense involved in maintaining a centralized server and as a way for businesses to exchange information with each other directly.

With respect to the how Internet P2P works, a user must first download and execute a peer-to-peer networking program. After launching the program, the user enters the IP address of another computer belonging to the network. (Typically, the Web page where the user got the download will list several IP addresses as places to begin). Once the computer finds another network member on-line, it will connect to that user's connection (who has gotten their IP address from another user's connection and so on). Users may also be able to choose how many member connections to seek at one time and determine which files they wish to share or password protect.

Push (or “server-push”) is the delivery of information on the Web that is initiated by the information server rather than by the information user or client, as it usually is. An early Web service that specialized in “pushing” information rather than having it “pulled” as the result of requests for Web pages was Pointcast, a site that provided up-to-date news and other information tailored to a previously defined user profile. Marimba was a somewhat similar site (and product) that pushed information to the user on a predefined schedule.

In fact, the information pushed from a server to a user actually comes as the result of a programmed request from the client in your computer. That is, any information pusher on the Web requires that you download a client program. This program captures your profile and then periodically initiates requests for information on your behalf from the server.

Another form of push is broadcast information. In this case, the information is pushed to everyone that has access to a particular channel or frequency. Broadcast usually (but not always) involves a continuous flow of information.

A further form of “pushed” information is e-mail. Although the e-mail client in your computer has to occasionally go to your local e-mail server to “pick up” the e-mail, the e-mail arrived because someone sent it (pushed) it to you without a one-for-one request having been made.

Media-On-Demand Framework

In accordance with an embodiment of the present invention, a Media On Demand (MOD) system is disclosed for providing a user-customizable, fully-animated TV-centric environment for browsing, selecting, previewing, purchasing, collecting, sequencing and controlling the full spectrum of digital media in the home—from TV to PVR, PPV to VOD, CD to DVD, digital music, photos, HDTV and beyond.

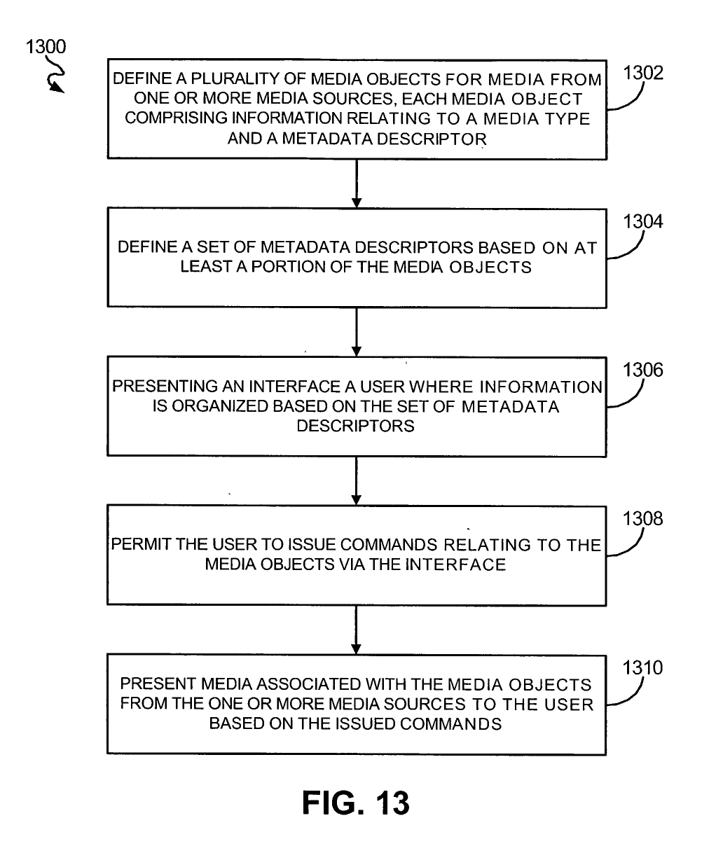

FIG. 13 is a flowchart of a process 1300 for presenting media integrated from a plurality of media sources to a user to provide an integrated media experience for the user in a media on demand framework in accordance with an embodiment of the present invention. A plurality of media objects are defined for associated media from one or more media sources in operation 1302. Each media object comprises information relating to a media type and a metadata descriptor. A set of metadata descriptors is defined based on at least a portion of the media objects in operation 1304. An interface is presented to a user through which information is organized based on the set of metadata descriptors in operation 1306. The user is permitted to issue commands relating to the media objects via the interface in operation 1308. Media associated with the media objects from the one or more media sources is presented to the user based on the issued commands in operation 1310.

In an embodiment of the present invention, the commands may include: browsing, selecting, previewing, purchasing, recording, collecting, sequencing and/or controlling the media objects. In another embodiment, the metadata descriptor of a media object may include information relating to: name of the media object, duration of the media object, genre of the media object, creator of the media object, affinity and parent groups of the media object, other media objects associated and linked to media object, rules for combining the media object with other media objects, owner of the media object, and/or value of the media object. In a further embodiment, visual objects associated with the media objects may be displayed to the user via the interface.

In yet another embodiment, the user may issue commands via a remote control. As an option in such an embodiment, commands may be issued via remote control commands by utilizing UP, DOWN, RIGHT, and/or LEFT arrow keys provided on remote control. In even another embodiment, one or more media objects may be linked together in response to at least one command issued by the user. In an additional embodiment, the interface may include a program guide that provides information about: media being presented to the user, media available for presenting to the user, and/or the order in which media objects can be combined and simultaneously presented to the user. In another embodiment, the media may be presented to the user via one or more frames on a visual display. In still another embodiment, the user may be permitted to search for media objects via the interface based on the metadata descriptors of the media objects. As an option, a plurality of media objects for media from one or more media sources may be locally cached (i.e., proximal to the user's end of the system) so that user access to each on demand media object can be expedited. As another option, the media associated with the media objects from the one or more media sources may be presented on demand to the user based on the issued commands.

In one embodiment of the present invention, the term “on demand” or “near on demand” may be defined as virtually instantaneous or having little delay between the issuing of the command and the presentation of the media in response to the issued command. In context of an exemplary embodiment of the present invention, on demand may be understood to mean similar to an experience that a television user encounters when selecting or changing channels using a remote control (i.e., issuing a command to change the channel via the, controls provided on the remote control)—the newly selected channel is presented to the television user nearly instantaneously after the user issues the command to change the channel via the remote control. Thus, in one embodiment of the present invention, “on demand” may be understood as meaning the outcome arising from the issuing of a command is presented to the user soon after the issuing of the command with little or slight delay (much like the delay between the user changing a channel of a television using a television remote control).

The present media on demand framework combines a self-teaching user experience; a full-spectrum TV-centric media integration approach; efficient hardware using the power and cost-effectiveness of multimedia PC architecture; and a sound and realistic business model to arrive at a recipe for viable iTV. That is, the present media on demand framework-enabled iTV will become the nerve center of the fully integrated Media-On-Demand (MOD) digital entertainment center.

Embodiments of the present media on demand framework may provide multiple opportunities to a variety of players and potential partners: network operators and broadcasters, hardware manufacturers, ISPs and broadband bandwidth providers, entertainment companies and others. Some of the revenue sources from services of the present media on demand framework may enable include: 1. Interactive Subscription Features for iTV services including video-on-demand, pay-per-view, music and game downloads, and others; 2. Sponsored Content—iTV may enable new forms of content that is accessible while watching TV. Many form factors are possible including sponsored short films (ala BMW films), Walled gardens, TV chat rooms, and specially designed and branded entertainment, financial and travel content, etc.; 3. Interactive and Targeted Advertisements—Viewers can click on commercial messages, links, or advertiser logos to get more information and place orders. Through data mining, vital information can be gathered about customers' preferences to offer more targeted advertising and offers; 4. T-Commerce—Television commerce allows consumers to pay for all online purchases—everything from premium cable services to retail transactions; and 5. Greater Audience Retention and Increased Viewer Loyalty—Viewers will reward those who offer more compelling and engaging TV by tuning in and returning for more.

Embodiments of the present media on demand framework may provide a navigator for all the digital media available in the home, whether stored locally on CD or DVD, on hard drives on the home network, broadcast from outside, or available on-demand from the Internet, Satellite, Wireless or Cable sources. Additional embodiments may include more compelling user interaction models, such as natural speech command, gestural control, wireless networking and even artificial intelligence.

With the advance of digital technology in the media industry and the widespread use of computers as the most facile means of media management, great progress has been made in the last decade toward providing consumers of digital media with a multiplicity of format and playback choices, as well as many different means for viewing, storing and managing media. For example, music can now be downloaded from the web in a variety of formats, streamed from web-based radio stations, purchased in CD or digital memory chip form, and recorded to Hard Disk, CD-R, MiniDisc, DAT, MP3 Player, etc. So too can video material be consumed and recorded by a variety of means and in a variety of formats.

However, despite the exciting facility of the desktop PC media environment, it has yet to overtake the inertia of TV ubiquity; there continues to be a disconnect between the usage patterns of media around the PC vs. TV or “Lean Forward vs. Sit Back” consumer behaviors in media purchase, consumption and management. Computers continue to be used as one-person devices ill-suited to replace TV-style media consumption, while TVs/stereos/home entertainment systems are perceived to be better suited to multiple viewers, and especially to broadcast, VHS or DVD video media, but are considerably less facile at providing access to non-linear or “new media.”The traditional home computer looks, feels, and functions much like the standard office computer. The traditional television is not suitable for computer usage. NetTV has invented a new and completely unique product that is a combination large screen television and computer with a number of unique identifying characteristics.

The media on demand framework may be used to leverage the strides made towards a hardware integration of the PC and TV form factors that combine a hybrid PC monitor/TV display with a PC-based computer deck running the latest Windows operating system. The present media on demand framework may be suitable for such a platform thereby extending this integration by encompassing user interaction models, forms of digital media integration, methods for the manipulation, purchase and consumption of these new media, and ways of presenting choices to the user by means of an extended program guide—all of which combine to afford users of an enhanced digital media experience.

In accordance with exemplary embodiments of the present invention, the combination television data monitor may be engineered to provide a unique feature set consisting of all of the following capabilities bundled together: 1. TV/Monitor with computer levels of display resolution at 640×480, 800×600 and optionally 1024×768, 2. Television display capabilities as a stand-alone device without the need for the computer deck to be turned on, 3. Selectable input for computer input (VGA 15 pin D-sub) and Television input (75 Ohm cable) or Audio Video (RCA phone type) connectors, via hand-held remote control device. Compatible with Television horizontal scanning frequency 15.7 KHz, Also compatible with Computer horizontal scanning frequency 31.5-37.8 KHz, 4. Built-in Stereo Speakers, amplifier, with capability to interface with a home stereo system, 5. The computer deck may also be designed to fit into a home entertainment console. Some of its features may include: being in a similar to the color of other consumer electronics home entertainment devices, have a low-profile design height of less than the industry standard 6″ height, enabling it to fit into the confines of most home entertainment cabinets, have an ability to run Microsoft DOS, Microsoft Windows, and/or the Macintosh operating system, and have an ability to receive and output to the combination television data monitor television broadcasts.

Embodiments of the present invention may include an input device that includes the combination of the following design elements: Remote control alphanumeric keyboard that utilizes IR (infrared) data transmission between keyboard's IR transmitter and the computer deck's IR receiver allowing the keyboard to be operated remotely from the computer deck, Remote control pointing device (mouse, touch pad, or trackball) that utilizes IR (infrared) data transmission between the pointing device's IR transmitter and the computer deck's IR receiver allowing the pointing device to be operated remotely from the computer deck.

The streaming media industry, while achieving breakthroughs in technology, characterized by greater levels of compression, improved qualities of audio and video, has none-the-less failed at achieving certain standards of ubiquity and seamless operation such as is typical of legacy entertainment systems such as television and radio. Users until now have located then played web-based digital audio and video media through a web-based search, or a digital entertainment or streaming media portal, methods designed for desktop PC internet users. Users of MP3 digital audio files have found comparatively more convenient methods to locate, download, then play digital music, however even these methods are still focused on the desktop PC user and not optimized for the easy “sit-back” style of usage to which living room entertainment users are accustomed.

The result has been slowness in the adoption rates of newer forms of digital media such as digital video, digital audio and digital still photos “new media”, by the mainstream of entertainment users. Slow adoption may be due, in part, to be a consequence of user's frustrating or futile efforts to locate then play newer forms of digital audio and digital video, as well as the failure of these to rise to the level of production quality inherent in modem television broadcast content. Users accustomed to a lifetime of instant access to television channels and radio stations teamed with the convenience of a remote control, expect their entertainment products to instantly deliver entertainment as they “surf” from a broad selection of choices.

The present invention may bridge the gap between heavily entrenched traditional media usage behavior and new media usage by creating a delivery, navigation and media management system that allows new media to be instantly served to the user in a fashion very similar to that which television and radio users are accustomed to. Application of embodiments of the present invention may result in instantaneous TV-like usability of newer forms of digital media such as digital video, digital audio and digital still photos. In addition the application of embodiments of the invention may provide a method for new media publication and distribution of a great body of media created and stored on users home systems at the “edge” of the internet including media created by other users, rather than the standard content creation industries. An additional application of embodiments of the present invention may provide a method of allowing a server to perform identification, permission verification, scheduling and file transfer initiation functions that permit the secure and timely transfer of the Broadcast Segments. The resulting new media broadcasts may offer an alternative to the commercial television and radio broadcast, as well as to more recent alternatives such as standalone DVD/VHS, DSS satellite or PVR hard disk recorders.

It is believed that the patterns of consumption of digital media will increasingly gravitate towards greater user sophistication and participation in controlling and customizing the media that is collected and consumed, even as familiar patterns of interaction established by the ubiquity of television viewing may be embraced and extended.

Universal Media Control

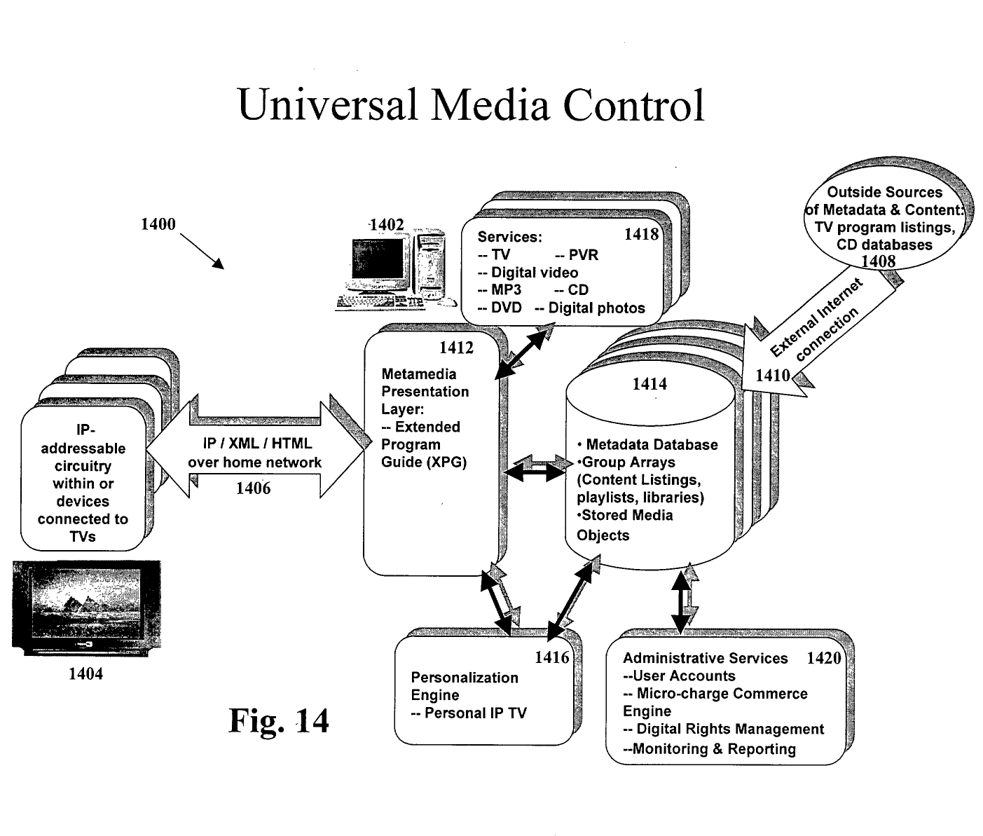

FIG. 14 is a schematic diagram of an exemplary implementation of a media on demand framework 1400 in accordance with an embodiment of the present invention. The framework comprises a plurality of applications that may reside on a computer such as a personal computer or workstation 1402. The framework's applications may be coupled to a video display 1404 such as a television, a combination television monitor and/or a monitor via a network 1406 such as, for example, a LAN. The applications may also be connected to external media sources 1408 of metadata, content, TV listings and CD databases via a network 1410 such as the Internet or other wide area network.

In addition, the framework 1400 may include a metamedia presentation layer 1412 which may further have an extended program guide, a metadata database 1414 that may contain content listings, play lists, libraries and stored media objects, and a personalization engine 1416. The framework may also provide media services 1418 such as, for example, television, personal video recording, digital video, MP3, CD, DVD, and digital photos. The framework may also include applications for providing administrative services 1420 such as, for example, user accounts maintenance, and digital rights management. The administrative services applications 1420 may also include a micro-charge commerce engine and monitoring and reporting applications.

The media on demand framework may present a user with an integrated set of Virtual Media Appliances controlled with a single TV-centric “metamedia” interface. The term “metamedia” may be used to describe the superset of media types which the media on demand framework can control, each component of which can be described by “metadata” textual information which allows the media type to be classified, sorted, and represented to the user for facilitating management and manipulation. Discrete or objective instances of a given media type plus its metadata descriptor may be referred to as a “media object.”Some illustrative examples of media objects include a song, a music video of that song, a CD or play list to which the song belongs, the cover image of that CD, or the album of one's own digital photos taken from the band's concert. Metamedia transcends the “multimedia” moniker often used to describe interactive digital media, inasmuch as this multiplicity of media types and media objects permits the media on demand framework to offer the user novel means of combining and sequencing media objects to create brand new ones—for example, one's own unique compilation of songs, music videos, recorded documentary and personal photos all pertaining to a given band. Thus a metamedia object may be as simple as a discrete media data object, or a pointer to a process or collection of objects or processes considered to be a “thing” by the user. This ability to nest and organize metamedia objects helps give users of the framework “Universal Media Control” over their media environments.

To achieve Universal Media Control (UMC), the media on demand framework defines a Superset of Metadata Descriptors for Media Objects, and then presents a user interface incorporating common concepts which unify the separate processes of browsing, selecting, previewing, purchasing, recording, collecting, sequencing and controlling these objects. These processes may encompass the full spectrum of digital media in the home—from broadcast TV programs to PVR digitally recorded ones, Pay-Per-View (PPV) events to streaming video-on-demand (VOD) program selections, optical media CD music to DVD movies, downloaded and locally-stored digital music as well as streamed internet radio, digital photos and still images to slide shows, HDTV presentation, Internet web browsing, email and instant messaging. and more.

In one embodiment, the media on demand framework may use an orthogonal remote-control navigation scheme (up, down, left, right, select) plus specific buttons on the remote to switch media modes, identify media objects, and act upon them. While distinguishing between the many types and formats of media objects, the framework may emphasize the similarities between them in order to make the process of identifying, managing, combining and consuming these objects common to all media types.

For example, all media objects have names, durations, genres, creators, affinity and parent groups, associated or linked media objects and rules by which they can easily or not so easily combine with other media objects. Broadcast channels have a time-sequenced array of programs called a schedule. CDs have a sequenced array of songs called a play list. Digital photo albums are an array of still images. Collections of Channels, CDs, Photo Albums, etc. are of a higher order, but still represent an array of parts arranged dimensionally.

By associating visual objects in the user interface with media objects and collections of media objects, and providing unique means for users to highlight, query, and act upon these associated visual objects, the media on demand framework may unify the ways in which the constituent parts and the collections of each of these different media types are represented to the user for manipulation and consumption. The user commands the functional focus using the remote control, and thus can move fluidly between commanding individual objects and object arrays (e.g. songs, play lists), groups of objects and group arrays (e.g. albums, discographies and libraries), application screens which control those objects (e.g. jukebox player), and meta application screens which control multiple simultaneous processes such as the framework's extended program guide itself.

Embodiments of the media on demand framework may also embrace and extends the MPEG-7 DS (Description System) Standard into a Superset of Metadata Descriptors so that Temporal information, Textual Annotation, Content Management, Creation Information, Usage Information, Media Description, Structural Description, Conceptual Description, Summaries, Variations, Usage and other descriptors may be used dynamically to sift, select and sequence the media objects to be managed.

Further embodiments of the media on demand framework may be used to represent both selectable and selected media objects in three- and multi-dimensional arrays, surfaces, volumes and topologies within the user interface.

Automatic Control and Integration of External Media Devices

While embodiments media on demand framework allow the user to drive a powerful set of internal virtual appliances—TV, MP3 Jukebox, DVD/CD Player, MP3 Player, Photo Sequencer, HDTV, PVR, etc. and integrate them seamlessly into an overall experience, the UI additionally may enable the control of adjacent media (or other) appliances using IR blast, etc. to achieve Universal Media Control of these devices as well. Just as a Universal Remote Control permits individuals to control multiple devices with a single remote unit, the media on demand framework may allow this control to take place automatically according to media scheduling, recording queue and other decisions made by the user within the framework's user interface and assigned to a media on demand framework box or device. These devices may include any IR-enabled media device such as DTVs, DVD Players, VHS Decks, TiVo and Replay-Style PVRs, Camcorders, Home Stereos or other devices. Thus the media on demand framework-enabled Set Top may be able to turn on an external media source, select a program source, and integrate it into the mix automatically—and may also be initiated or scheduled remotely via the framework's web-based interface using an internet connection.

Apart from the facility this grants users to select and sequence programs, songs, photos, etc., this Universal Media Control allows users to combine these simultaneously in interesting ways—for example to display a chosen TV channel while monitoring another channel as it is recorded, all while playing music from a combination of CD, MP3, and streaming internet radio. Visually, this multiple-process management is made easier by the use of multiple “Picture-in-Picture” capability.

Embodiments of the media on demand framework may also be enabled to know which internal appliances and which external devices are required to store, retrieve, play, record and combine the media objects requested by the user or the processes he sets in motion. Thus, the user need only specify the events that should take place in terms of the media objects themselves, and all switching and data transfer between devices is handled automatically by the framework.

This approach provides a way by which multiple devices and media sources are integrated into a single metamedia library of entertainment content accessible with the unifying media on demand framework interface. This user-centric approach helps to answer the need that media consumers have to organize and sequence their experience of multiple media sources without having to make the distinction of where the media objects are stored—locally, digitally, optically, on a distant server, in a TV broadcast, etc., or what file format or device is needed to present that content at any given time.

Extended Programming Guide (XPG) for Compiling and Presenting an Interactive Metamedia Schedule.

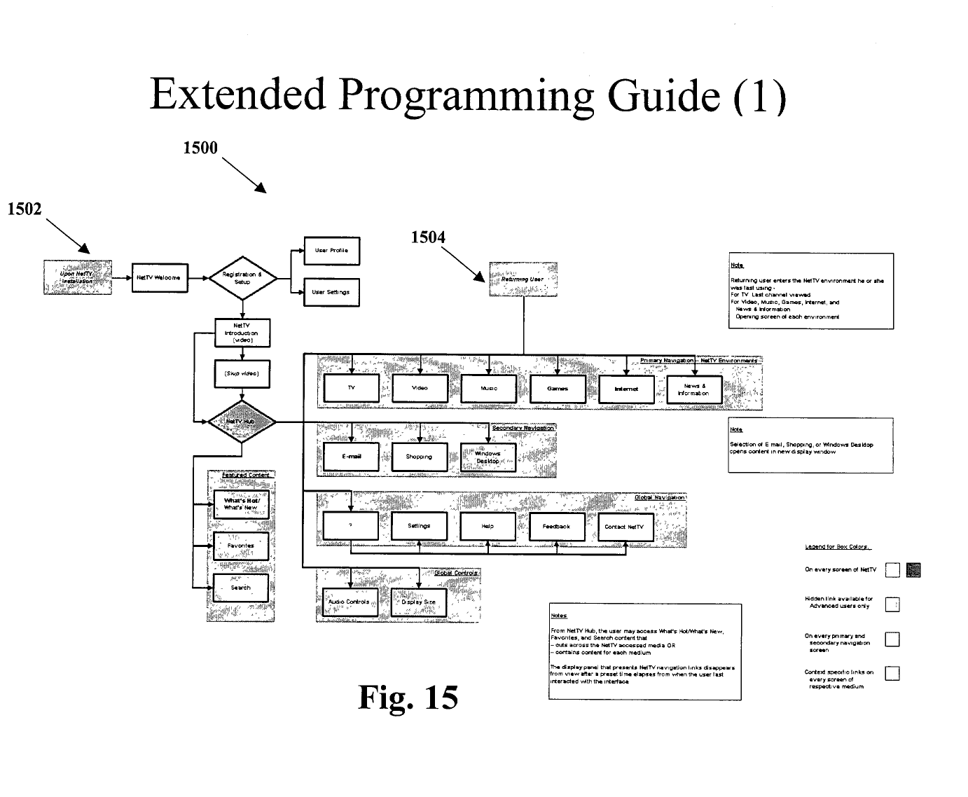

FIG. 15 is a screen navigation flow diagram 1500 in an extended programming guide in a media on demand framework in accordance with an embodiment of the present invention.

FIG. 15 illustrates an exemplary sequence of screens displayed to a new user 1502 and to a returning user 1504.

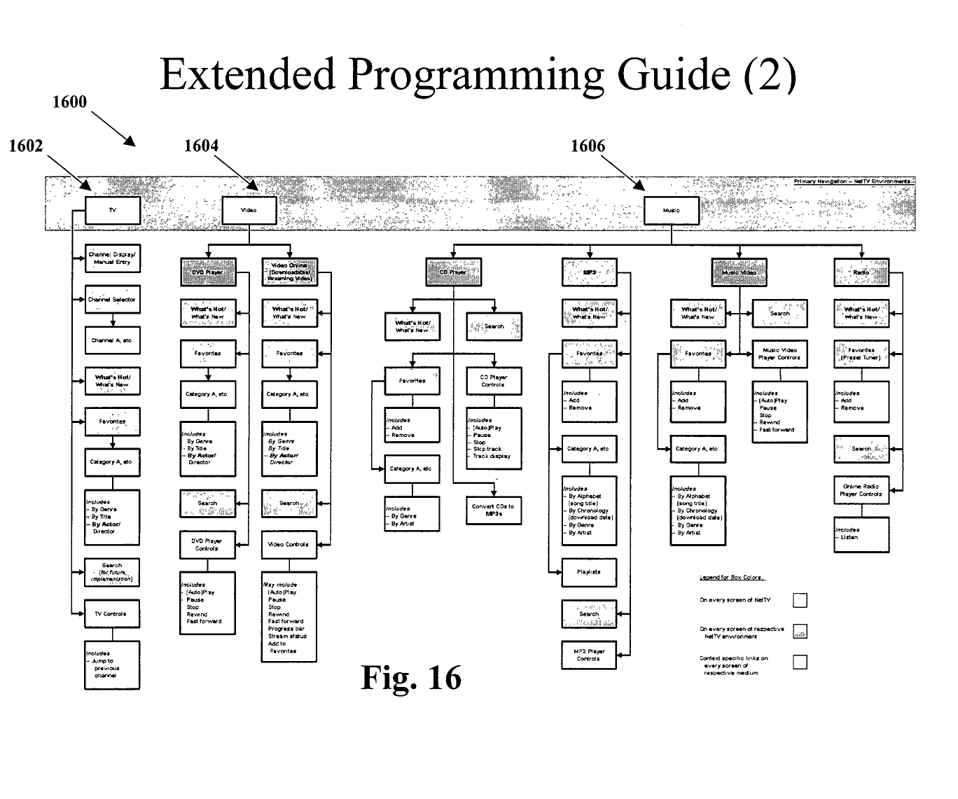

FIG. 16 is a screen navigation flow diagram 1600 for presenting television, video and music media in an extended programming guide in a media on demand framework in accordance with an embodiment of the present invention. FIG. 16 illustrates an exemplary sequence of screens displayed to a user relating to television 1602, video 1604 and music 1606 media.

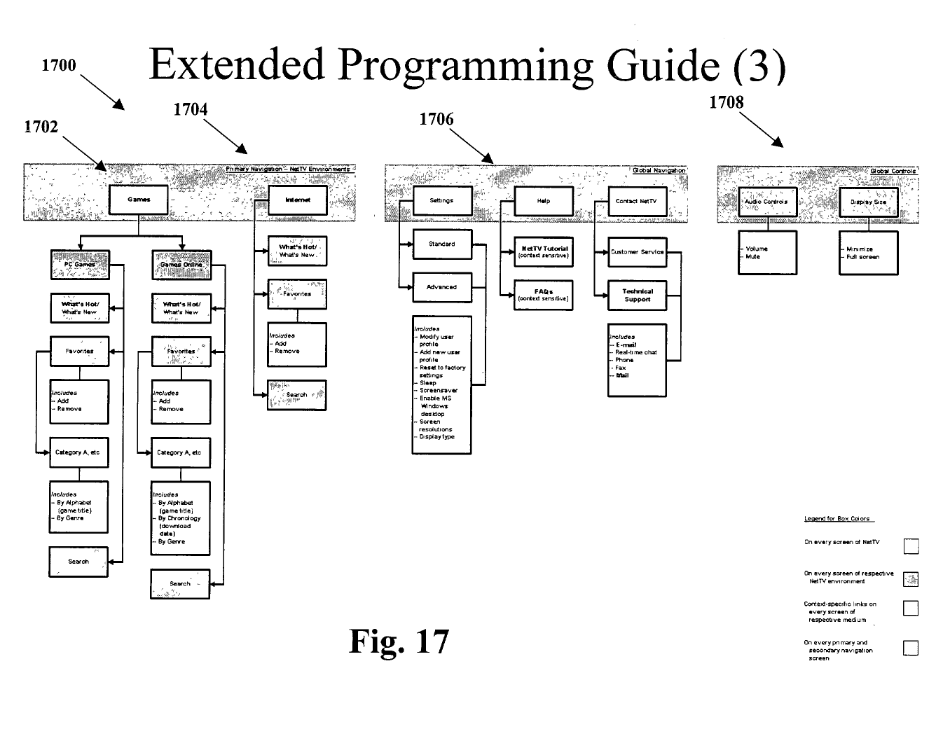

FIG. 17 is a screen navigation flow diagram 1700 for presenting games and Internet media in an extended programming guide in a media on demand framework in accordance with an embodiment of the present invention. FIG. 17 illustrates an exemplary sequence of screens displayed to a user relating to games 1702 and Internet 1704 media. FIG. 17 also illustrates an exemplary sequence of screens displayed to a user relating to global navigation 1706 and global controls 1708 in a media on demand framework.

The explosion of media types and viewing/listening/interacting choices makes one's task of deciding what media to consume and how to manage it a daunting one. Just as the framework may specify and report a common Superset of Metadata Descriptors for Media Objects and then presents a “metamedia” user interface incorporating common concepts for browsing, selecting, previewing, purchasing, recording, collecting, sequencing and controlling these objects, embodiments of the framework may extend this structure to present a form of Electronic Program Guide (EPG) that may be referred to as an Extended Program Guide (XPG)

In the world of advanced and digital television, EPGs are dynamically compiled from data sources such as Tribune Media and presented to users within the context of user interfaces built in to set top boxes and cable-ready TVs, VCRs and PVRs. EPGs are primarily schedules, filtered and sorted by time, channel, title, topic, etc. The common elements of the EPG user interface are stored locally in the set top, and the dynamic data—mostly text and some still pictures—are expressed within this local interface. In embodiments of the XPG, the idea is extended to embrace the framework's interleaving of multiple digital media modes in the same XPG context, including the many interactive processes that can be performed on a given media object such as recording, caching, sequencing, meta-tagging, streaming, enabling VOD transactions, sponsorship links, etc.

In the same spirit of embracing and extending the experiential conventions of the TV experience, the XPG bears some resemblance to the modem EPGs employed on advanced TVs, Cable Boxes, DSS Satellite Systems and PVR recorders. All of these use certain accepted conventions of user interaction, such as the highlighting of buttons on the screen and the execution of functions using a “select” button, channel up/down and other modal buttons on the remote. However, the XPG may be much more than a schedule of “what's on;” more to the point, the XPG may be a schedule planner of what media is or can be made available, in what order, combined and/or simultaneously presented at any given time.

A uniqueness of this approach is the way in which the XPG represents the combined superset of entertainment choices as one multi-dimensional yet contiguous spectrum of media objects—a metamedia library of entertainment content made accessible within the unifying framework's interface. Choices made within the XPG drive “trigger events” for the internal media appliances as well as the external multiple devices. This approach helps answer the need that media consumers have to organize and sequence their experience of multiple media sources without having to make the distinction of where the media objects are stored—locally, digitally, optically, on a distant server, in a TV broadcast, etc., or what file format or device is needed to present or record that content at any given time.

Embodiments of the present media on demand framework may use its IP connection (and potentially other input/output sources) to periodically download program data, streaming web radio and PPV schedules, artist and track data from the Gracenote database or other media information sources, and integrates these with a database of local assets to present the user with an integrated spectrum of media objects to choose from. Media objects are filtered by metadata and presented in navigable arrays on user interface screens which are themselves treated like arrayed objects. The user commands the XPG's functional focus using the remote control, and thus can move fluidly between commanding individual objects and object arrays (e.g. songs, play lists), groups of objects and group arrays (e.g. albums, discographies and libraries), application screens which control those objects (e.g. jukebox player), and meta-application screens which control multiple simultaneous processes such as the XPG itself.

Thus, the XPG may allow users to select from and schedule processes encompassing the full spectrum of digital media in the home—from broadcast TV programs to PVR digitally recorded ones, Pay-Per-View (PPV) events to streaming video-on-demand (VOD) program selections, optical media CD music to DVD movies, downloaded and locally-stored digital music as well as streamed internet radio, digital photos and still images to slide shows, HDTV presentation, Peer-to-PeerTV (P2PTV), Dynamic Compilations, and more. Further, the XPG may allow multiple processes to occur simultaneously, and in some cases, to be combined (e.g. listening to a play list of music or an internet radio station while viewing the picture from a live TV broadcast, DVD, or previously recorded program.

Multiple Picture-in-Picture for Multimedia Control and Selection

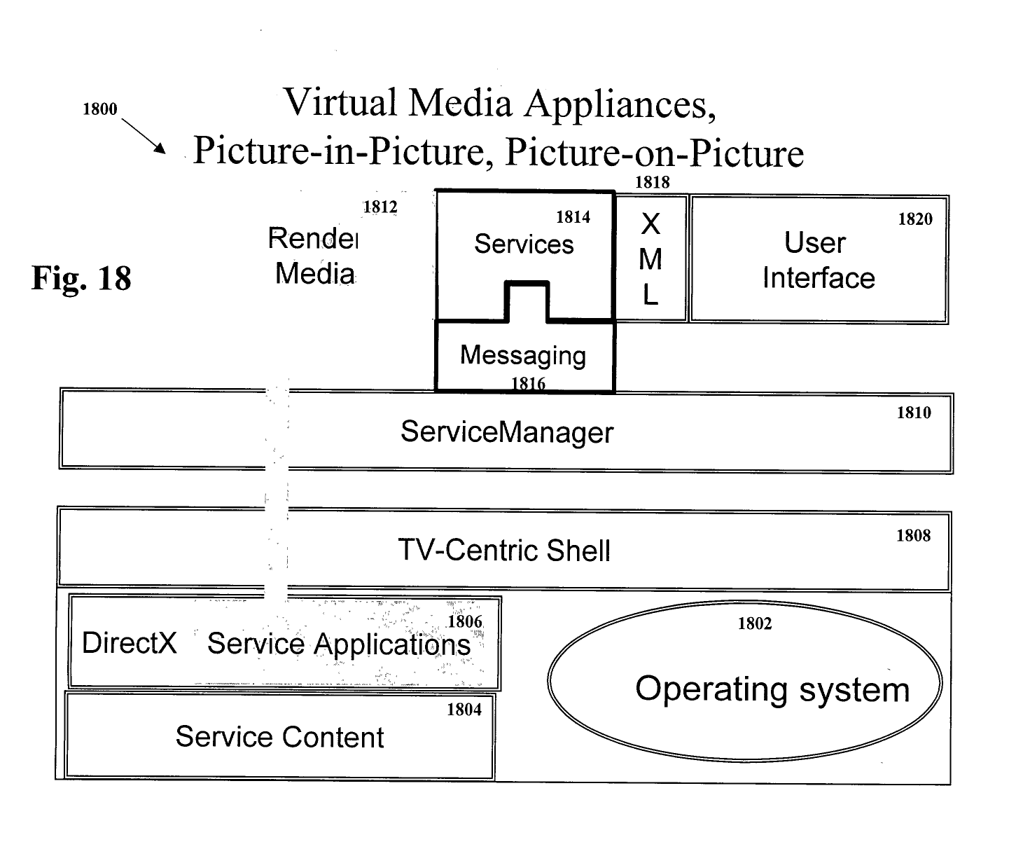

FIG. 18 is a schematic diagram of a virtual media appliance stack 1800 for providing picture-in-picture and picture-on-picture capabilities in a media on demand framework in accordance with an embodiment of the present invention. The stack comprises operating system 1802, service content 1804, DirectX and service applications 1806, TV-centric shell 1808, service manager 1810, render media 1812, services 1814, messaging 1816, XML 1818, and user interface 1820 layers.

The media on demand framework's user interface and remote functions make novel use of multiple “Picture-in-Picture” displays to enable the enjoyment and control of multiple simultaneous media modes. Because of the multiple media sources and processes that users can combine and switch between in the framework's environment, a multiple “Picture-in-Picture” capability may be implemented to allow users to monitor up to three simultaneous media processes while retaining primary focus on a fourth. This allows users ease in browsing, selecting, previewing, purchasing, recording, collecting, sequencing and controlling media objects in multiple simultaneous modes. Any media mode within the framework may be manipulated in this way from broadcast TV programs to PVR digitally recorded ones, Pay-Per-View (PPV) events to streaming video-on-demand (VOD) program selections, optical media CD music to DVD movies, downloaded and locally-stored digital music as well as streamed internet radio, digital photos and still images to slide shows, HDTV presentation, and more.

In ordinary picture-in-picture capability built in to dual-tuner TV sets, a user can watch one program while monitoring another channel or flipping channels in a small picture-in-picture screen superimposed in a comer of the larger screen. Conversely, users can change channels in the primary screen and monitor another in the small screen. A typical application of this feature is the monitoring of a sports event while watching a movie or other program.

In the present framework this idea may be taken even further by applying the notion of multiple picture-in-picture capability not only to the viewing of channels, but to monitoring and controlling media processes within the interactive interface itself. A simple example is the display of channel content in the picture-in-picture window in the XPG guide. For example, the when the user is watching a given TV program and wishes to see what else is possible to view or hear, the “Guide” button on the remote will change the primary screen to the XPG, placing the current channel in the first Picture-in-Picture window in the upper left of the screen. As the user explores alternative program choices or media object alternatives such as PVR pre-recorded videos, songs, slideshows, etc. the Picture-in-Picture visual changes to represent this content choice. In the case of live television, this is a display of the actual signal received by the tuner. In the case of stored video, this could be a title screen, key frame, or actual read-ahead from a scene within the video; in the case of a slideshow or still frame, a small version of these would be displayed; music might be represented by an album cover, band photo or display of music visualization calculated by the song itself. Each Picture-in-Picture frame has a label on the bottom third of the frame which identifies the channel, object title, process, mode or screen which the Picture-in-Picture represents.

A more complex example might proceed like this: While navigating alternate choices, the PVR scheduler indicates that another program that is to be recorded is about to be broadcast. A pop-up dialog presents itself to ask the user if he wants to change channels, monitor the recorded channel in Picture-in-Picture, or simply allow the recorder to do its work in the background. At this point, the XPG screen itself could be monitored in a second Picture-in-Picture while the primary screen viewing the program being recorded and the first Picture-in-Picture displayed the original program still tuned in on tuner number one. A third process might be added if the user desired to listen to music instead of the TV audio signal accompanying the picture of the primary screen.

The media on demand framework's Picture-in-Picture features may also be used to mange the “focus” which applies to media control. For example, in the latter example, we may want to adjust the volume of the music playing in the background while we watch a different program and monitor other processes. The media on demand framework's Picture-in-Picture features frames may become “buttons” which can be highlighted or given “focus” like any other interactive element in the interface. As with buttons, the highlighted or focused element is indicated by the display of a highlighted rectangle around it. By using the orthogonal (up, down, right, left) buttons on the remote, we highlight the third Picture-in-Picture representing the music process, and tap the volume button on the remote. This tells the framework that we want to adjust the volume of the Picture-in-Picture process rather than the master frame. Subsequent presses of the volume up/down will adjust music volume. Pressing fast-forward/reverse or channel up/down will have the desired effect in either case, to move within the song or change songs accordingly. If we highlight the tuned TV program in Picture-in-Picture two, we can change the channel being monitored without affecting the music in the background coming from the music process in Picture-in-Picture three, and so on.

PVR for Personal Videos and Microediting for PersonalTV

Existing PVR technology focuses on the recording of discrete programs or series of programs from broadcast, cable and satellite television schedules. In the media on demand framework, PVR may do all this but additionally extend to offer users the ability to create “PersonalTV” by recording, storing and editing smaller segments of any digital medium—e.g. Single music videos, favorite movie scenes, individual commercials, or even firewire input of one's own video from a digital camcorder. Then, users may be enabled to create rudimentary edits combining video snippets, photo slideshows, CD or MP3 music etc. to create their own sequences. These may then be subsequently represented in the XPG guide for future use. Embodiments of the present invention may also be enabled to support the Peer-to-Peer Bitcast of one's own creations to other users via a P2P network (P2PTV).

Embodiments of the present media on demand framework may be used to provide personal customized media. The framework presents a collection of methods for organizing, publishing and distributing (collectively “Broadcasting”), then locating, taking delivery, and displaying (collectively “Viewing”) new forms of digital media, such as digital audio, digital video, digital photos (collectively “New Media”) that aggregately result in a seamless, easily-navigable viewing and listening experience similar to that which a television currently provides.

Involved are at least two User operated computing devices on which reside the invention, which is a software program (“the Program”) and one server (Master Agent). Users of the invention can be viewers and listeners of New Media (“Viewers”), or distributors of New Media (“Broadcasters”) (the Program allows one to be either a Viewer or a Broadcaster). Broadcasters can create a collection consisting of one or more digital media types for broadcast using a variety of third-party applications such as are commonplace on the personal computer, or through special client software tools that allow the Broadcaster to select an organize digital media files in a chosen order, insert text or graphics or other similar objects, and to save and store that organized media (“Broadcast Segment”) and link it to a specific Channel. A Broadcast Segment may be an original collection of digital media clips or an update to a previously broadcast Broadcast Segment. The Method allows the Broadcaster to grant certain permissions to allow Viewers to view, and schedule the delivery of, the Broadcast Segment. Broadcasters can store and broadcast one or more Broadcast Segments at a time. Viewers can be selected either individually or by interest group, work project group, community or organization or any other desired grouping. The organized media (“Broadcast Segment”) is then linked by the Broadcaster to a Broadcaster-identified button on the user interface of the software program, which button is known as a “Channel”. The Broadcast then initiates a Intention to transmit Notice, whi9ch is either sent to the Master Agent or, alternatively, can be sent directly to the Viewer. The on line/off line status of the Viewers computer is determined, and if on line, the viewer is provided certain information about the Broadcast Segment, such as the Broadcaster's Name, size of the download, and the Broadcast description of the Broadcast Segment's content. The Viewer is then given the option to accept or refuse the download of the Broadcast Segment. Once the Broadcast Segment is downloaded, the program creates a Channel on the Viewer's computer that corresponds to the Broadcaster's selected Channel name. The Viewer may see one or more such Channels, depending on the number of previous downloads. The Viewer may select one or more channels, driven by the applicant's client server software, to view the Broadcast Segment. Viewers may store and queue Viewer-selected Broadcast Segments into one or more channels.

Dynamic Metamedia Compilation

By combining the power of dynamic search and filtering with the metamedia presentation engine of the invention, media on demand framework has the power to represent “programs” in its guide which do not even exist as discrete local or broadcast media objects, but rather as dynamically-gathered compilations of scenes, sequences, newsbytes, etc. which can be presented by the framework to the user on demand or automatically by subscription. In this case, it is not necessary to take up hard disk space for PVR compilations of material; the compilations may consist of virtual EDLs (edit decision lists) which are pointers to media objects or regions of objects, as well as instructions for the temporal (editing) and spatial (compositing) manner in which these objects are combined. Creates broadcasts using a like-like assembler of media segments.

A simple example of this is an “AutoDJ” function whereby a user specifies keywords, genre descriptors, transitions, duration, etc. and the framework compiles a song and begins to play songs or clips in a specified order for the specified duration, combining these with visualizations, slideshows, video snippets, etc. and adding transitions between the media objects to create a composite whole.

The notion of dynamic compilation may be utilized to provide revenue opportunities. In the music industry, soundtracks and compilations are one of the fastest-growing categories of music retail, owing to the perception that the purchaser gets more “hits” for their dollar than on traditional CDs. Similarly, there are certain kinds of metamedia compilations that can be created programmatically and delivered to the user as content in and of themselves. As an example, the framework may include the ability to specify and automatically compile and archive music videos from MTV, VH1 and other music channels. Currently, PVRs only allow the recording of discrete video programs containing many different videos along with commercials. Another example of dynamic compilation may be customized news where only pre-specified topics, filtered by scanning closed-caption text, would be aggregated from numerous news channels in order to re-present “news for one.”

The information used to search and sort may comprise of the Superset of Metadata Descriptors. In addition to Closed Caption text (CC), traditional EPG data, Temporal information, Textual Annotation, Content Management, Creation Information, Usage Information, Media Description, Structural Description, Conceptual Description, Summaries, Variations, Usage and other descriptors may be used dynamically to sift, select and sequence the media objects to be dynamically compiled. Similarly, the rights information embedded in the metadata descriptors may be also used in combination with a procedural transaction engine to calculate micropayements and charge viewers single fees on-demand for compilations consisting of many possible rights transactions.

Dynamic Metamedia Compilation employs the “metadata” textual information which allows the media type to be classified, sorted, and represented to the user for facilitating management and manipulation. Metamedia transcends the “multimedia” moniker often used to describe interactive digital media, inasmuch as this multiplicity of media types and media objects permits the embodiments of the present invention to offer the user novel ways of combining and sequencing media objects to create brand new ones—for example, one's own unique compilation of songs, music videos, recorded documentary and personal photos all pertaining to a given band. Thus a metamedia object may be as simple as a discrete media data object, or a pointer to a process or collection of objects or processes.

The framework defines a Superset of Metadata Descriptors for Media Objects, and then presents a user interface incorporating common concepts which unify the separate processes of browsing, selecting, previewing, purchasing, recording, collecting, sequencing and controlling these objects. These processes may encompass the full spectrum of media objects and object arrays from broadcast/satellite/cable TV programs to PVR digitally recorded ones, Pay-Per-View (PPV) events to streaming video-on-demand (VOD) program selections, optical media CD music to DVD movies, downloaded and locally-stored digital music as well as streamed internet radio, digital photos and still images to slide shows, HDTV presentation, Internet web browsing, email and instant messaging. etc.

While distinguishing between the many types and formats of media objects, the media on demand framework of the present invention may also emphasize the similarities between them in order to make the process of identifying, managing, combining and consuming these objects common to all media types. For example, all media objects have names, durations, genres, creators, affinity and parent groups, associated or linked media objects and rules by which they can easily or not so easily combine with other media objects. Broadcast channels have a time-sequenced array of programs called a schedule. CDs have a sequenced array of songs called a play list. Digital photo albums are an array of still images. Collections of Channels, CDs, Photo Albums, etc. are of a higher order, but still represent an array of parts arranged dimensionally.

By associating visual objects in the user interface with media objects and collections of media objects, and providing unique means for users to highlight, query, and act upon these associated visual objects, the media on demand framework may be utilized to unify the ways in which the constituent parts and the collections of each of these different media types are represented to the user for manipulation and consumption. The user commands the functional focus using the remote control, and thus can move fluidly between commanding individual objects and object arrays (e.g. songs, playlists), groups of objects and group arrays (e.g. albums, discographies and libraries), application screens which control those objects (e.g. jukebox player), and meta-application screens which control multiple simultaneous processes such as the XPG itself.

Embodiments of the media on demand framework may also embrace and extend the MPEG-7 DS (Description System) Standard into a Superset of Metadata Descriptors so that Temporal information, Textual Annotation, Content Management, Creation Information, Usage Information, Media Description, Structural Description, Conceptual Description, Summaries, Variations, Usage and other descriptors may be used dynamically to sift, select and sequence the media objects to be managed.

3D Visual Navigation of Media Objects

The Metadata superset may also be used to represent both selectable and selected media objects in three- and multi-dimensional arrays, surfaces, volumes and topologies within the user interface.

The media on demand framework may also include an “All Media Player” (AMP) presents a complete spectrum of digital media choices to the user, representing each media object on or as a “surface” which is manipulated in the user interface as a three-dimensional object. Inasmuch as the framework understands and represents media objects and object arrays to the user as visual objects and visual arrays, media management choices and tasks may be presented as navigable, three-dimensional and multi-dimensional arrays where motion through the media space has specific meaning and reward.

Embodiments of the framework's presentation engine may exploits the inherently 3D nature of modem graphics chips for fast, realtime manipulation and layering of these surfaces in order to present information and media objects to the user for interaction. Embodiments of the present invention may extend this idea to represent the management of the multiple objects and groups of one's metamedia library as a navigable, many-layered three-dimensional construct. This capability may be carried out in part using the technology disclosed in U.S. Pat. No. 6,005,578 “A Method and Apparatus for the Visual Navigation of Information Objects” which is incorporated by reference herein.

Modulating Baseband Audio Output then Combining that Output with Broadcast Channels.

In an embodiment of the present invention an RF Modulator section may be provided that that transforms baseband audio video captured via a cable used to connect the Sound output from the PC to the stereo audio inputs (right-left) of the RF Modulator. The signal is then modulated into a designated UHF or VHF channel such between VHF channel 2 and UHF channel 125. The resultant audio video output can then be transported via the standard RF-75 coaxial cable installed in the vast majority of homes so as to be potentially viewed on any television attached to the installed coax.

In addition, the modulated channel may also then be combined with UHF, VHF, Cable, and/or Satellite channels from sources such as Terrestrial Antennas, Cable Set Top Receivers, or Satellite Receivers so that the Home PC “plays” on a designated channel, for example Channel 3, throughout the home. This method combines the output of the designated VHF or UHF with the existing UHF and VHF channels. A channel combiner module provides a pass-through of all existing VHF and UHF channels except for the designated channel. It then accepts the input from a second source, in this invention the modulated input from the Home PC, inserts it along with the existing channels to the installed coax cable. The existing channels display normally with the exception of the designated channel. If any of the televisions attached to the installed coax is tuned to the designated channel (i.e., Channel 3), the audio video outputs of the Home PC are displayed on the TV to provide Full Internet capability, full access to digital media, VOD, PVR, and other forms of Media on demand and media services on the users TV at the selected channel.

Remote Operation of a PC by RF Remote with Display on TV

In accordance with an embodiment of the present invention, when a viewer has selected the designated channel on which the PC data is being broadcast as set forth above, this method offers a way to signal the remote Home PC using a handheld wireless Radio Frequency remote control (RF-based handheld remote control operating at a 900 MHz frequency) for the Home PC that operates at distances of up to 100 feet. Alternatively, an Infrared Receiver can be utilized to signal back to the Home PC. A viewer watching digital media outputs from the Home PC on a television elsewhere in the home can control the operation of the Home PC remotely. In doing so, the viewer can actually see the effect of the control on the television being viewed elsewhere in the house-it looks to the viewer that he is controlling the TV, not the remote computer. The handheld remote is capable of driving the Home PC hosting the media on demand framework. Television viewers tuned to the designated channel will enjoy the perception of interacting with the local television although technically their interactions are broadcast back to the Home PC to provide viewing control. This component may immerse the viewer in a highly interactive television experience, effectively combining the view ability of the television with the communication and power of the PC.

RF Base

In an embodiment of the present invention, an external HW device may be connected to the PC which combines the RF-modulator described in above, the channel combiner (also described above) with the RF-based handheld remote control base that wirelessly links the user back to the Home PC, into a single plug and play solution.

In one embodiment of the present invention, the media on demand framework may be optionally implemented utilizing either utilizing software and/or logic running a stand along PC-based set-top box. As another option, the media on demand framework may be implemented utilizing a distributed home network. This way, instead of this software and/or logic running on a single stand-alone set-top box, the software and/or logic may run on different devices in a home network that connects home PCs and PC-TV bridge devices, game consoles (e.g., Microsoft's Xbox or Sony's PS2), or even a MPEG4 decoder card inside a HDTV or even a videocassette-sized adapter box connectable to a user's TV, VCR or stereo using with a standard AV cable (e.g., such as the commonly found type having red, white and yellow connectors. In an embodiment emplemented utilizing a videocassette-sized adapter box, the adapter may be designed to work with existing TVs and stereo systems and may be compatible with a PC. In such an embodiment, the adapter may display to the user a simple menu, easily managed with a standard remote control, on the user's TV screen to permit the user to choose the music option, and you should get a directory of all the MP3 or Windows Media Audio files on your PC hard drive. As an illustrative example, the user may click on a symbol displayed on the menu called “Pictures,” and the user will then see a list of JPEG images, ready for display one by one or as an automatic slide show.

In one embodiment of the present invention, the media on demand framework may utilize an architecture known as Universal Plug and Play (UPnP), which is designed to enable diverse devices to recognize and communicate with each other. While the framework may be implemented on a physical network such as an Ethernet network, the network may also utilize wireless networks such as 802.11a and/or 802.11b wireless technology (also known as “WiFi”).

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for presenting media to a user in a media on demand framework, comprising:
defining a plurality of media objects for media from one or more media sources, wherein each media object comprises information relating to a media type and a metadata descriptor;
defining a set of metadata descriptors based on at least a portion of the media objects;
presenting an interface a user wherein information is organized based on the set of metadata descriptors;
permitting the user to issue commands relating to the media objects via the interface; and
presenting media associated with the media objects from the one or more media sources to the user based on the issued commands.

2. The method of claim 1, wherein the commands include at least one of: browsing, selecting, previewing, purchasing, recording, collecting, sequencing, and controlling the media objects.

3. The method of claim 1, wherein the metadata descriptor of a media object includes information relating to at least one of: name of the media object, duration of the media object, genre of the media object, creator of the media object, affinity and parent groups of the media object, other media objects associated and linked to media object, rules for combining the media object with other media objects, owner of the media object, and value of the media object.

4. The method of claim 1, wherein visual objects associated with the media objects are displayed to the user via the interface.

5. The method of claim 1, wherein the user issues commands via a remote control.

6. The method of claim 5, wherein commands are issued via remote control commands by utilizing at least one of UP, DOWN, RIGHT, and LEFT arrow keys provided on remote control.

7. The method of claim 1, wherein one or more of the media objects are be linked together in response to at least one command issued by the user.

8. The method of claim 1, wherein the interface includes a program guide that provides information about at least one of: media being presented to the user, media available for presenting to the user, and the order in which media objects can be combined and simultaneously presented to the user.

9. The method of claim 1, wherein the media is presented to the user via one or more frames on a visual display.

10. The method of claim 1, wherein the user is permitted to search for media objects via the interface based on the metadata descriptors of the media objects.

11. A system for presenting media to a user in a media on demand framework, comprising:
logic for defining a plurality of media objects for media from one or more media sources, wherein each media object comprises information relating to a media type and a metadata descriptor;
logic for defining a set of metadata descriptors based on at least a portion of the media objects;
logic for presenting an interface a user wherein information is organized based on the set of metadata descriptors;
logic for permitting the user to issue commands relating to the media objects via the interface; and
logic for presenting media associated with the media objects from the one or more media sources on demand to the user based on the issued commands.

12. The system of claim 11, wherein the commands include at least one of: browsing, selecting, previewing, purchasing, recording, collecting, sequencing, and controlling the media objects.

13. The system of claim 11, wherein the metadata descriptor of a media object includes information relating to at least one of: name of the media object, duration of the media object, genre of the media object, creator of the media object, affinity and parent groups of the media object, other media objects associated and linked to media object, rules for combining the media object with other media objects, owner of the media object, and value of the media object.

14. The system of claim 11, wherein visual objects associated with the media objects are displayed to the user via the interface.

15. The system of claim 11, wherein the user issues commands via a remote control.

16. The method of claim 15, wherein commands are issued via the remote control utilizing at least one of UP, DOWN, RIGHT, and LEFT arrow keys provided on remote control.

17. The system of claim 11, wherein one or more of the media objects are be linked together in response to at least one command issued by the user.

18. The system of claim 11, wherein the interface includes a program guide that provides information about at least one of: media being presented to the user, media available for presenting to the user, and the order in which media objects can be combined and simultaneously presented to the user.

19. The system of claim 11, wherein the media is presented to the user via one or more frames on a visual display.

20. The system of claim 11, wherein the user is permitted to search for media objects via the interface based on the metadata descriptors of the media objects.

21. A computer program product for presenting media to a user in a media on demand framework, comprising:
computer code for defining a plurality of media objects for media from one or more media sources, wherein each media object comprises information relating to a media type and a metadata descriptor;
computer code for locally caching a plurality of media objects for media from one or more media sources, wherein user access to each on demand media object can be expedited;
computer code for defining a set of metadata descriptors based on at least a portion of the media objects;
computer code for presenting an interface a user wherein information is organized based on the set of metadata descriptors;
computer code for permitting the user to issue commands relating to the media objects via the interface; and
computer code for presenting media associated with the media objects from the one or more media sources to the user based on the issued commands.

22. The computer program product of claim 21, wherein the commands include at least one of: browsing, selecting, previewing, purchasing, recording, collecting, sequencing, and controlling the media objects.

23. The computer program product of claim 21, wherein the user issues commands via a remote control.

24. The computer program product of claim 23, wherein commands are issued via the remote control utilizing at least one of UP, DOWN, RIGHT, and LEFT arrow keys provided on remote control.
